(19) United States
(12) Patent Application Publication
(10) Pub. No.: US 2012/0051364 A1
(43) Pub. Date: Mar. 1, 2012

(54) DISTRIBUTED ROUTING ACCORDING TO LONGEST MATCH PRINCIPLE

(75) Inventors: MANABU FUJITA, Kawasaki (JP); Masaya Arai, Atsugi (JP); Shinji Nozaki, Kawasaki (JP); Akihiko Akitaya, Kawasaki (JP); Kensuke Ino, Kamakura (JP)

(73) Assignee: ALAXALA Networks Corporation

(21) Appl. No.: 13/198,237

(22) Filed: Aug. 4, 2011

(30) Foreign Application Priority Data
Sep. 1, 2010 (JP) 2010-195250

(51) Int. Cl. H04L 12/56

(52) U.S. Cl. 370/401

(57) ABSTRACT

A network relay system includes a plurality of internal network relay devices. The network relay system learns multiple pieces of route information to an external network, creates a plurality of allocation route tables designed to allocate the learnt multiple pieces of route information to the internal network relay devices. The network relay system then generates address space information showing a correlation of IP address ranges on an IP address space between the allocation route tables and respectively registers the allocation route tables, along with the generated address space information, in the internal network relay devices. Each of the internal network relay devices transfers a data frame, based on the address space information and the allocation route table registered in the self-device.

### CROSS-REFERENCE TO RELATED APPLICATIONS

The present application claims the priority based on Japanese Patent Application No. 2010-195250 filed on Sep. 1, 2010, the disclosure of which is hereby incorporated by reference in its entirety.

### BACKGROUND

The present invention relates to relaying a data frame by routing or optimal path selection in the computer network.

A method proposed to effectively share the routing process in the computer network to a plurality of resources registers multiple pieces of route information showing available paths for routing in units of the route information in a distributive manner in a plurality of network relay devices. Each of the network relay devices performs the routing process with regard to a data frame, which is correlated to route information registered in the self-network relay device.

The route information used for routing correlates a transfer destination, to which a data frame with a destination IP address belonging to an IP address range is to be transferred, to the IP address range as the allocation range of the destination IP address of the data frame. The IP address range is also called CIDR (Classless Inter-Domain Routing) block and is expressed by the combination of an IP address and a prefix length (for example, “10.0.0.0/8” or “10.0.0.0/16”).

The routing based on the route information distributed to the plurality of network relay devices is performed without sufficiently considering the longest match rule. On the assumption of registry of two pieces of route information “10.0.0.0/8” and “10.0.0.0/16”, for example, a data frame having a destination IP address “10.1.1.1” is to be transferred by the route information “10.0.0.0/16” having the longer prefix length between the registered two pieces of route information according to the longest match rule. In the case where these two pieces of route information are distributed to two different network relay devices, however, the routing according to the longest match rule may not be performed successfully.

By taking into account at least part of the issue discussed above, there is a need to effectively share the routing process in the computer network to a plurality of resources.

### SUMMARY

In order to address at least part of the requirement described above, the invention provides various aspects and embodiments described below.

One aspect of the invention is directed to a network relay device configured to interconnect a plurality of external networks. The network relay device includes: a plurality of relay modules configured to cooperatively construct an internal network for relaying a data frame, which is to be sent and received between the plurality of external networks; and a route learner configured to learn multiple pieces of route information. Each piece of the route information shows a route, through which the data frame is to be transferred from the internal network to one of the external networks, and correlates an IP address range as an allocation range of a destination IP address of the data frame to a transfer destination of the data frame, which is to be transferred from the internal network to the one of the external networks. The network relay device also includes: a route allocator configured to create a plurality of allocation route tables respectively corresponding to the plurality of relay modules, wherein the multiple pieces of route information learnt by the route learner are allocated to the plurality of allocation route tables in units of the route information; a space information generator configured to generate address space information showing a correlation of multiple IP address ranges on an IP address space between the multiple pieces of route information allocated to the plurality of allocation route tables; and a route registrator configured to respectively register the plurality of allocation route tables, along with the generated address space information, in the plurality of relay modules. Each of the plurality of relay modules transfers the data frame, based on the address space information and the allocation route table registered in the self-relay module by the route registrator. In the network relay device according to this aspect of the invention, each of the plurality of relay modules performs the routing process according to the longest match rule, based on the address space information. This arrangement enables the routing process in the computer network to be effectively shared to the plurality of relay modules according to the longest match rule.

According to one preferable embodiment, the space information generator may generate information that is correlated to each of the multiple pieces of route information allocated to the plurality of allocation route tables and shows whether route information in an IP address range belonging to a common IP address space and having a longer prefix length is allocated to another allocation route table among the plurality of allocation route tables, as the address space information. In the network relay device of this embodiment, each of the plurality of relay modules determines the longest match between the route information registered in the self-relay module and the route information registered in the other relay modules, and implements the routing process according to the longest match rule.

According to another preferable embodiment, each of the plurality of relay modules may include: a receiver configured to receive the data frame; a route searcher configured to search the allocation route table registered in the self-relay module by the route registrator for route information corresponding to a destination IP address of the data frame received by the receiver; a first transferrer configured to, when address space information correlated to the route information searched by the route searcher indicates absence of the route information having the longer prefix length, set a destination address in a data link layer of the data frame received by the receiver, based on the route information searched by the route searcher, and transfer the data frame to the set destination address; and a second transferrero configured to, when the address space information correlated to the route information searched by the route searcher indicates presence of the route information having the longer prefix length, transfer the data frame received by the receiver, in order to set the destination address in the data link layer of the data frame, based on the route information having the longer prefix length among pieces of route information searched by the route searchers of the plurality of relay modules. The network relay device of this embodiment implements the routing process according to the longest match rule, based on the address space information indicating the presence or absence of any candidate for the longest match.

According to another preferable embodiment, the space information generator may include: a first generator configured to generate a plurality of aggregated address ranges by shortening prefix lengths of respective IP address ranges in the multiple pieces of route information learnt by the route learner and aggregating the IP address ranges having the shortened prefix lengths; and a second generator configured to create an IP space allocation table in which the plurality of aggregated address ranges are allocated to the plurality of relay modules, as the address space information. The route allocator may allocate the multiple pieces of route information learnt by the route learner in units of the route information, based on the created IP space allocation table, so as to create the plurality of allocation route tables. In the network relay device of this embodiment, each of the plurality of relay modules implements the routing process without determining the longest match with the route information registered in the other relay modules.

According to another preferable embodiment, each of the plurality of relay modules may include: a receiver configured to receive the data frame; a first transferrer configured to, when route information corresponding to a destination IP address of the data frame received by the receiver is present in the allocation route table registered in the self-relay module by the route registrator, set a destination address in a data link layer of the data frame received by the receiver, based on the allocation route table registered in the self-relay module by the route registrator, and transfer the data frame to the set destination address; and a second transferrer configured to, when the route information corresponding to the destination IP address of the data frame received by the receiver is not present in the allocation route table registered in the self-relay module by the route registrator, refer to the address space information registered in the self-relay module by the route registrator and transfer the data frame to a relay module, in which the route information corresponding to the destination IP address of the received data frame is registered. The network relay device of this embodiment implements the routing process according to the longest match rule, based on the address space information of the aggregated address ranges.

According to another preferable embodiment, each of the plurality of relay modules may include an instruction adder configure to, when the data frame is to be transferred to another relay module among the plurality of relay modules, add notification information, which is to be notified to the another relay module, to the data frame. The notification information may include at least one of: first information identifying the another relay module in the internal network; second information representing an operation requested to the another relay module; third information representing a candidate for the route, through which the data frame is to be transferred to the one of the external networks; and fourth information representing one or multiple relay modules, which the data frame has gone through, among the plurality of relay modules. The network relay device of this embodiment may further include: an ARP learner configured to learn multiple pieces of address resolution protocol or ARP information, each piece of the ARP information correlating a destination address of a data link layer to each of transfer destination IP addresses, which are correlated as the transfer destinations to the IP address ranges of the multiple pieces of route information; an APR allocator configured to create a plurality of ARP tables, to which the multiple pieces of ARP information learnt by the ARP learner are allocated in units of the ARP information, according to allocation of the multiple pieces of route information to the plurality of allocation route tables; and an ARP registrator configured to respectively register the plurality of ARP tables in the plurality of relay modules. In the network relay device of this embodiment, required pieces of ARP information are registered in a distributive manner in the respective relay modules, according to the pieces of route information distributed to the respective relay modules. The network relay device of this embodiment can adequately transfer the data frame, based on the notification information.

According to another preferable embodiment, the network relay device may further include: a source address learner configured to learn multiple pieces of source address information, each piece of the source address information correlating a source address of the data link layer of the data frame to each of the destination addresses in the multiple pieces of ARP information; a source address allocator configured to create a plurality of source address tables, to which the multiple pieces of source address information learnt by the source address learner are allocated in units of the source address information, according to allocation of the multiple pieces of ARP information to the plurality of ARP tables; and a source address registrator configured to respectively register the plurality of source address tables in the plurality of relay modules. In the network relay device of this embodiment, required pieces of source address information are registered in the respective relay modules, according to the pieces of ARP information distributed to the respective relay modules.

According to another preferable embodiment, the route allocator may create the plurality of allocation route tables, such that an identical piece of the route information is allocated in a duplicative manner to at least two allocation route tables. On the occurrence of failure in one of the plurality of relay modules, the network relay device of this embodiment enables the routing process to be continued, based on the route information registered in another normal relay module.

According to another preferable embodiment, each of the plurality of relay modules may be operable in parallel as the route learner, the router allocator, the space information generator and the route registrator, and a relay module to be operated in parallel as the route learner, the router allocator, the space information generator and the route registrator may be selected among the plurality of relay modules. In the network relay device of this embodiment, the selected relay module is operated to perform the series of processing from learning to registration of the route information. On the occurrence of failure in part of the plurality of relay modules, this arrangement enables the routing process to be resumed by another normal relay module.

According to another preferable embodiment, each of the plurality of relay modules may include a route notifier configured to notify an external network connected with the self-relay module via a link aggregation among the plurality of external networks, of an IP address range in the allocation route table registered in the self-relay module by the route registrator. In the network relay device of this embodiment, each of the plurality of relay modules more actively receives a data frame with a destination IP address belonging to the IP address range allocated to the self-relay module, from the external network connected via the link aggregation. This arrangement enhances the transfer speed of the data frame in the internal network.

According to another preferable embodiment, the multiple pieces of route information may form a virtual private network or VPN. The network relay device of this embodiment enables the routing process in the VPN to be effectively shared to the plurality of relay modules according to the longest match rule.

According to another preferable embodiment, the plurality of relay modules may be individually provided as a plurality of independent, separate network relay devices, and the plurality of independent, separate network relay devices may cooperatively work as a virtual single network relay device. In the virtual single network relay device according to this embodiment, the routing process can be effectively shared to the plurality of relay modules provided as the plurality of independent, separate network relay devices, according to the longest match rule.

Another aspect of the invention is directed to a network relay system configured to interconnect a plurality of external networks. The network relay system includes; a plurality of network relay devices configured to cooperatively construct an internal network for relaying a data frame, which is to be sent and received between the plurality of external networks; and a route learner configured to learn multiple pieces of route information. Each piece of the route information shows a route, through which the data frame is to be transferred from the internal network to one of the external networks, and correlates an IP address range as an allocation range of a destination IP address of the data frame to a transfer destination of the data frame, which is to be transferred from the internal network to the one of the external networks. The network relay system also includes; a route allocator configured to create a plurality of allocation route tables respectively corresponding to the plurality of network relay devices, wherein the multiple pieces of route information learnt by the route learner are allocated to the plurality of allocation route tables in units of the route information; a space information generator configured to generate address space information showing a correlation of multiple IP address ranges on an IP address space between the multiple pieces of route information allocated to the plurality of allocation route tables; and a route registrator configured to respectively register the plurality of allocation route tables, along with the generated address space information, in the plurality of network relay devices. Each of the plurality of network relay devices transfers the data frame, based on the address space information and the allocation route table registered in the self-network relay device by the route registrator. In the network relay system according to this aspect of the invention, each of the plurality of network relay devices determines the longest match between the route information registered in the self-network relay device and the route information registered in the other network relay devices, based on the address space information. This arrangement enables the routing process in the computer network to be effectively shared to the plurality of network relay devices according to the longest match rule.

Still another aspect of the invention is directed to a network relay method of interconnecting a plurality of external networks. The network relay method interconnects a plurality of network relay devices to cooperatively construct an internal network for relaying a data frame, which is to be sent and received between the plurality of external networks, and learns multiple pieces of route information, wherein each piece of the route information shows a route, through which the data frame is to be transferred from the internal network to one of the external networks, and correlates an IP address range as an allocation range of a destination IP address of the data frame to a transfer destination of the data frame, which is to be transferred from the internal network to the one of the external networks. The network relay method creates a plurality of allocation route tables respectively corresponding to the plurality of network relay devices, wherein the learnt multiple pieces of route information are allocated to the plurality of allocation route tables in units of the route information, generates address space information, which shows a correlation of multiple IP address ranges on an IP address space between the multiple pieces of route information allocated to the plurality of allocation route tables, and respectively registers the plurality of allocation route tables, along with the generated address space information, in the plurality of network relay devices. Each of the plurality of network relay devices transfers the data frame, based on the address space information and the allocation route table registered in the self-network relay device. According to the network relay method in this aspect of the invention, each of the plurality of network relay devices determines the longest match between the route information registered in the self-network relay device and the route information registered in the other network relay devices, based on the address space information. This arrangement enables the routing process in the computer network to be effectively shared to the plurality of network relay devices according to the longest match rule.

Another aspect of the invention is directed to a network relay device configured to relay a data frame. The network relay device includes: a plurality of interfaces configured to cooperatively form a single virtual interface by means of a link aggregation; an allocation learner configured to learn an IP address range as an allocation range of a destination IP address of the data frame, which is to be routed by each of connection destinations connected with the plurality of interfaces, from the each connection destination, in correlation to a interface corresponding to the each connection destination; and a transferrer configured to, when the destination IP address of the data frame, which is to be sent from the virtual interface, belongs to the IP address range learnt by the allocation learner, transfer the data frame from the interface correlated to the IP address range by the allocation learner among the plurality of interfaces. The network relay device according to this aspect of the invention enhances the transfer speed of a data frame in the computer network, which the connection destination connected via the link aggregation belongs to.

The invention may be actualized by diversity of other applications in addition to the network relay device, the network relay system and the network relay method discussed above, for example, a component as part of the network relay device and a program to be performed by the computer to implement the functions of the network relay device. The invention is not restricted to any of the aspects and embodiments discussed above but may be actualized in diversity of other aspects and embodiments within the scope of the invention.

### BRIEF DESCRIPTION OF THE DRAWINGS

The invention will be described with reference to the accompanying drawings in which:

FIG. 1 is an explanatory diagram showing the configuration of a computer network according to a first embodiment of the invention;

FIG. 2 is an explanatory diagram showing IP addresses set in respective network interfaces included in the computer network;

FIG. 3 is an explanatory diagram showing the structure of an internal network relay device;

FIG. 4 is an explanatory diagram showing the detailed structure of a controller included in the internal network relay device;

FIG. 5 is an explanatory diagram showing the detailed structure of a transfer module included in the internal network relay device;

FIG. 6 is a schematic explanatory diagram showing the frame structure of a data frame to be transferred between a plurality of the internal network relay devices;

FIG. 7 is a flowchart showing a protocol processing device specification process performed by the controller of the internal network relay device;

FIG. 8 is an explanatory diagram showing internal route tables;

FIG. 9 is a flowchart showing a transfer preparation process performed by the controller of the internal network relay device;

FIG. 10 is an explanatory diagram showing learnt route information;

FIG. 11 is an explanatory diagram showing learnt ARP information;

FIG. 12 is an explanatory diagram showing learnt source address information;

FIG. 13 is an explanatory diagram showing allocation route tables;

FIG. 14 is an explanatory diagram showing ARP tables;

FIG. 15 is an explanatory diagram showing source address tables;

FIG. 16 is a flowchart showing a transfer process performed by the transfer module of the internal network relay device;

FIG. 17 is a flowchart showing the transfer process performed by the transfer module of the internal network relay device;

FIG. 18 is a flowchart showing the transfer process performed by the transfer module of the internal network relay device;

FIG. 19 is an explanatory diagram showing one example of data frame transfer n the first embodiment;

FIG. 20 is an explanatory diagram showing the updated allocation route tables;

FIG. 21 is an explanatory diagram showing the allocation route tables reallocated for the purpose of restoration on the occurrence of failure;

FIG. 22 is an explanatory diagram showing allocation route tables in modified example 1 of the first embodiment;

FIG. 23 is an explanatory diagram showing the detailed structure of a transfer module included in an internal network relay device according to a second embodiment of the invention;

FIG. 24 is a flowchart showing a transfer preparation process performed in the second embodiment;

FIG. 25 is an explanatory diagram showing generation of aggregated address ranges;

FIG. 26 is an explanatory diagram showing an IP space allocation table;

FIG. 27 is an explanatory diagram showing allocation route tables in the second embodiment;

FIG. 28 is an explanatory diagram showing ARP tables in the second embodiment;

FIG. 29 is an explanatory diagram showing source address tables in the second embodiment;

FIG. 30 is a flowchart showing a transfer process performed by the transfer module of the internal network relay device in the second embodiment;

FIG. 31 is a flowchart showing the transfer process performed by the transfer module of the internal network relay device in the second embodiment;

FIG. 32 is an explanatory diagram showing one example of data frame transfer in the second embodiment;

FIG. 33 is an explanatory diagram showing the updated aggregated address ranges in the second embodiment;

FIG. 34 is an explanatory diagram showing the updated IP space allocation table in the second embodiment;

FIG. 35 is an explanatory diagram showing the updated allocation route tables in the second embodiment;

FIG. 36 is an explanatory diagram showing the IP space allocation table reallocated for the purpose of restoration on the occurrence of failure in the second embodiment;

FIG. 37 is an explanatory diagram showing an IP space allocation table in a modified example of the second embodiment;

FIG. 38 is an explanatory diagram showing the structure of an internal network relay device according to a third embodiment of the invention;

FIG. 39 is an explanatory diagram showing the structure of an external network relay device in the third embodiment;

FIG. 40 is an explanatory diagram showing a link allocation table in the third embodiment; and

FIG. 41 is an explanatory diagram showing one example of data frame transfer in the third embodiment.

### DESCRIPTION OF THE EMBODIMENTS

The aspects and advantages of the invention described above will become more apparent from the following detailed description of the computer networks by way of examples of the invention, with reference to the accompanying drawings.

### A. First Embodiment

A1. Configuration of Computer Network

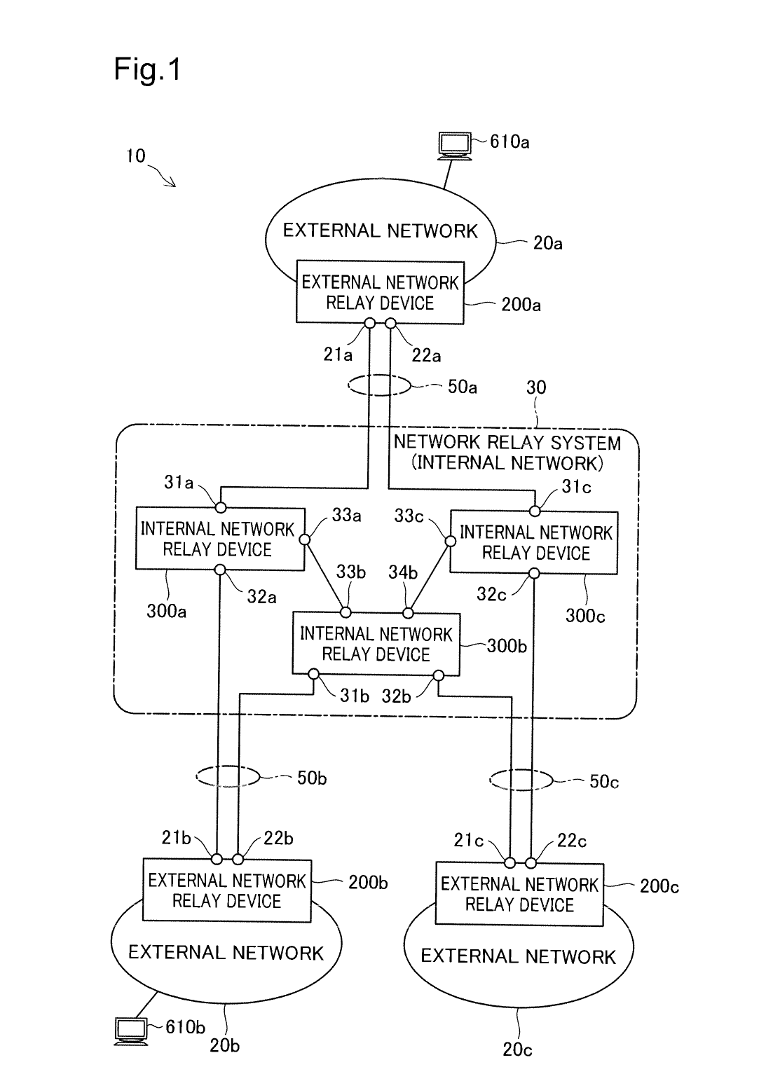

FIG. 1 is an explanatory diagram showing the configuration of a computer network 10. The computer network 10 includes a plurality of external networks 20 and a network relay system 30, which interconnects the plurality of external networks 20.

In the configuration of this embodiment, the plurality of external networks 20 send and receive an Ethernet (registered trademark)-based data frame via the network relay system 30. The plurality of external networks 20 interconnected by means of the network relay system 30 cooperatively work to construct a local area network (hereafter referred to as “LAN”). The plurality of external networks 20 may simply construct a single LAN or may additionally construct a virtual LAN (hereafter referred to as “VLAN”) as a logical network group set independently of the physical connections in the LAN.

In the configuration of this embodiment, three external networks 20 are interconnected by means of the network relay system 30. The number of interconnected external networks 20 is, however, not limited to three, but may be two or may be four or a greater number in other embodiments. In the description of this embodiment, the external network is generally represented by the numerical symbol “20”, and a specific external network is represented by the numerical symbol “20” with a suffix of an alphabetical letter. In the illustrated example of FIG. 1, the three external networks are respectively shown by the symbols “20a”, “20b” and “20c”.

Each of the plurality of external networks 20 includes an external network relay device 200 configured to relay a data frame to the network relay system 30. In this embodiment, the external network relay device 200 is a network relay device called a layer 3 switch or a router, which adopts the transfer system complying with IP (Internet Protocol) as the protocol of the network layer in the OSI (Open System Interconnection) reference model or with Ethernet as the protocol of the data link layer in the OSI reference model.

In the description of this embodiment, the external network relay device is generally represented by the numerical symbol “200”, and a specific external network relay device is represented by the numerical symbol “200” with a suffix of an alphabetical letter corresponding to the alphabetical letter allocated to the external network, in which the specific external network relay device is included. In the illustrated example of FIG. 1, an external network 20a includes an external network relay device 200a. Similarly an external network 20b includes an external network relay device 200b, and an external network 20c includes an external network relay device 200c.

The external network relay device 200 includes a plurality of network interfaces complying with the IP protocol and the Ethernet protocol to send and receive a data frame. In the illustrated example of FIG. 1, the external network relay device 200a includes two network interfaces 21a and 22a. Similarly the external network relay device 200b includes two network interfaces 21b and 22b, and the external network relay device 200c includes two network interfaces 21c and 22c.

The external network 20 includes a terminal device 610 configured to perform various operations and computations. In the description of this embodiment, the terminal device included in the external network 20 is generally represented by the numerical symbol “610”. A terminal device included in a specific external network 20 is represented by the numerical symbol “610” with a suffix of an alphabetical letter corresponding to the alphabetical letter of the suffix allocated to the specific external network 20. For example, the symbol “610a” represents a terminal device included in the external network 20a, and the symbol “610b” represents a terminal device included in the external network 20b.

The network relay system 30 includes a plurality of internal network relay devices 300 working as a plurality of relay modules cooperatively construct an internal network configured to relay a data frame between the plurality of external networks 20. In this embodiment, the internal network relay device 300 is a network relay device called as a layer 3 switch or a router, which adopts the transfer system complying with IP or Ethernet.

In this embodiment, the plurality of internal network relay devices 300 are individually independent network relay devices. Cooperation of the plurality of internal network relay devices 300 enables the network relay system 30 to integrally serve as a virtual signal network relay device. In another embodiment, the network relay system 30 may be designed as a single network relay device including the plurality of internal network relay devices 300 in the form of components incorporated in a casing. In the description of the embodiment, the internal network relay device is generally represented by the numerical symbol “300”, and a specific internal network relay device is represented by the numerical symbol “300” with a suffix of an alphabetical letter. In the illustrated example of FIG. 1, three internal network relay devices are respectively shown by the symbols “300a”, “300b” and “300c”.

The internal network relay device 300 includes a plurality of network interfaces complying with the IP protocol and the Ethernet protocol to send and receive a data frame. In the illustrated example of FIG. 1, the internal network relay device 300a includes three network interfaces 31a, 32a and 33a. The internal network relay device 200b includes four network interfaces 31b, 32b, 33b and 34b. The internal network relay device 200c includes three network interfaces 31c, 32c and 33c. In the description of this embodiment, the plurality of network interfaces included in the internal network relay device 300 are generally represented by the sequential numerical symbols “31”, “32”, “33” and “34”. A specific network interface included in a specific internal network relay device 300 is represented by the corresponding numerical symbol with a suffix of an alphabetical letter corresponding to the alphabetical letter allocated to the specific internal network relay device 300.

The internal network relay device 300a and the internal network relay device 300b are interconnected by means of the network interfaces 33a and 33b. The internal network relay device 300b and the internal network relay device 300c are interconnected by means of the network interfaces 34b and 33c.

The external network relay device 200a and the internal network relay device 300a are interconnected by means of the network interfaces 21a and 31a. The external network relay device 200a and the internal network relay device 300c are interconnected by means of the network interfaces 22a and 31c. The two connection lines, i.e., the connection line formed by the network interfaces 21a and 31a and the connection line formed by the network interfaces 22a and 31c, cooperatively work to configure a link aggregation 50a as a virtual single network interface.

The external network relay device 200b and the internal network relay device 300a are interconnected by the network interfaces 21b and 32a. The external network relay device 200b and the internal network relay device 300b are interconnected by the network interfaces 22b and 31b. The two connection lines, i.e., the connection line formed by the network interfaces 21b and 32a and the connection line formed by the network interfaces 22b and 31b, cooperatively work to configure a link aggregation 50b as a virtual single network interface.

The external network relay device 200c and the internal network relay device 300b are interconnected by means of the network interfaces 21c and 32b. The external network relay device 200c and the internal network relay device 300c are interconnected by means of the network interfaces 22c and 32c. The two connection lines, i.e., the connection line formed by the network interfaces 21c and 32b and the connection line formed by the network interfaces 22c and 32c, cooperatively work to configure a link aggregation 50c as a virtual single network interface.

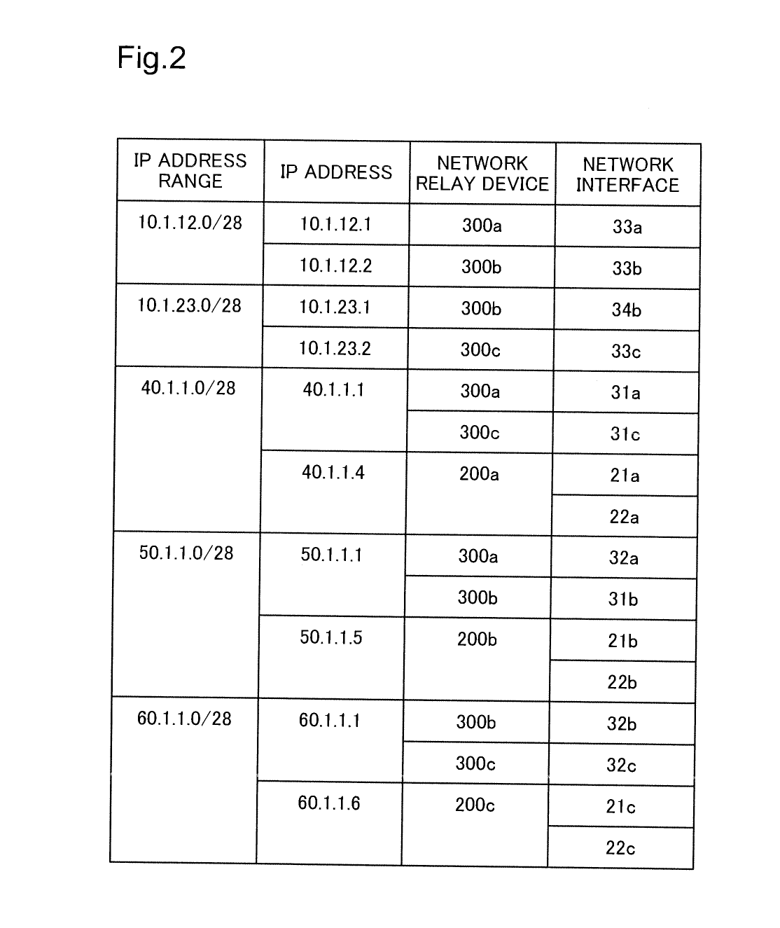

FIG. 2 is an explanatory diagram showing IP addresses set in the respective network interfaces included in the computer network 10. The fourth column of FIG. 2 is “network interface” column showing a symbol for identifying a specified network interface. The third column of FIG. 2 is “network relay device” column showing a symbol for identifying a specified external network relay device or a specified internal network relay device including the specified network interface in the fourth column. The second column of FIG. 2 is “IP address” column showing an IP address set in the specified network interface in the fourth column. The first column of FIG. 1 is “IP address range” column showing an IP address range, to which the IP address of the second column belongs, for each connection line.

Among the IP address ranges shown in the first column of FIG. 2, the IP address ranges “10.1.12.0/28” and “10.1.23.0/28” are allocated to internal routes for sending and receiving a data frame between the internal network relay devices 300a, 300b and 300c in the network relay system 30 and are provided as route information that is not notified to the external network relay devices 200.

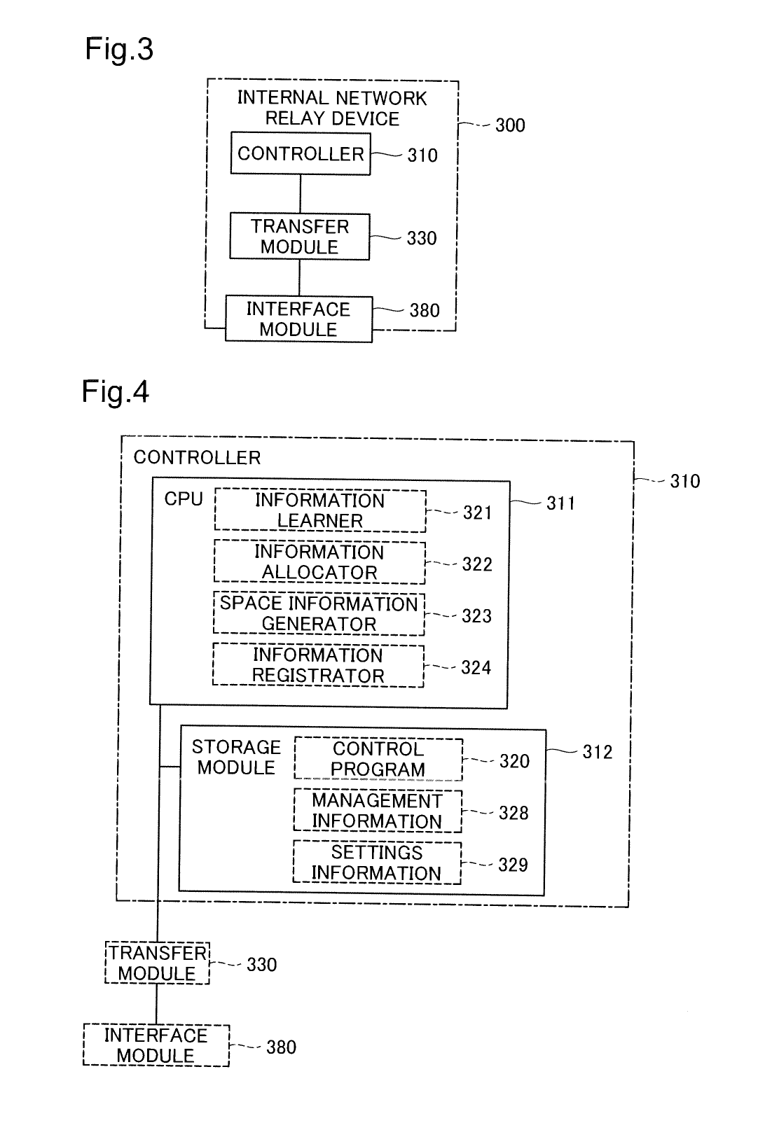

FIG. 3 is an explanatory diagram showing the structure of the internal network relay device 300. The internal network relay device 300 includes a controller 310, a transfer module 330 and an interface module 380. The controller 310 of the internal network relay device 300 controls the operations of the transfer module 330 and the interface module 380. The transfer module 330 of the internal network relay device 300 performs series of operations to transfer a data frame received at the interface module 380 to another network relay device. The interface module 380 of the internal network relay device 300 includes a plurality of network interfaces, for example, Ethernet-based twist pair cables and optical fibers in this embodiment. The external network relay device 200 has structure similar to the structure of the internal network relay device 300 shown in FIG. 3.

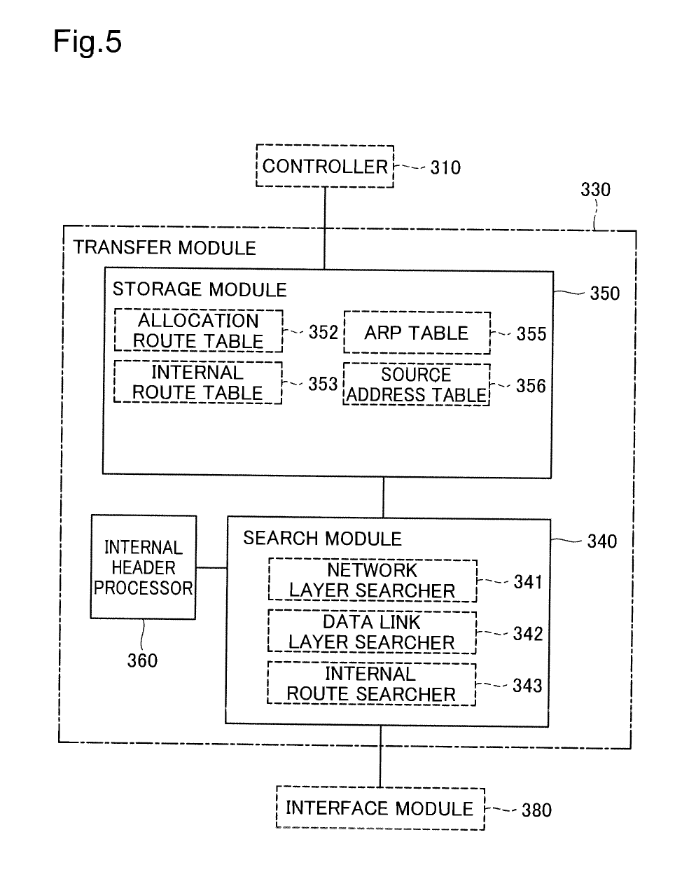

FIG. 4 is an explanatory diagram showing the detailed structure of the controller 310 included in the internal network relay device 300. FIG. 5 is an explanatory diagram showing the detailed structure of the transfer module 330 included in the internal network relay device 300. The controller 310 includes a CPU (central processing unit) 311 and a storage module 312. The transfer module 330 includes a search module 340, a storage module 350 and an internal header processor 360.

The CPU 311 of the controller 310 performs various operations according to a control program 320 stored in the storage module 312. In this embodiment, the CPU 311 performs operations based on a routing protocol, such as OSPF (Open Shortest Path First) or BGP (Border Gateway Protocol). The storage module 312 of the controller 310 stores various pieces of information for managing the operations of the transfer module 330 and the interface module 380 in the form of management information 328 and various pieces of information set by the administrator of the network relay system 30 in the form of settings information 329, in addition to the control program 320.

The search module 340 of the transfer module 330 searches the information stored in the storage module 350 for information required to transfer a data frame, based on the information included in the data frame. The search module 340 includes a network layer searcher 341, a data link layer searcher 342 and an internal route searcher 343. The network layer searcher 341 of the search module 340 refers to a destination IP address registered in an IP header attached to a data frame and searches for a transfer destination IP address used for identification of a transfer destination of the network layer, to which the data frame is to be transferred. The data link layer searcher 342 of the search module 340 refers to the transfer destination IP address searched by the network layer searcher 341 and searches for a destination MAC address used for identification of a destination of the data link layer, to which the data frame is to be sent. The data link layer searcher 342 also refers to the searched destination MAC address and searches for a network interface as the destination of the data frame to be sent. The internal route searcher 343 of the search module 340 refers to the destination IP address registered in the IP header attached to the data frame and searches for an internal route to send and receive a data frame between the plurality of internal network relay devices 300 included in the network relay system 30.

The storage module 350 of the transfer module 330 stores information used for transferring a data frame. The storage module 350 stores an allocation route table 352, an internal route table 353, an ARP table 355 and a source address table 356. The details of the respective tables stored in the storage module 350 will be discussed later.

The internal header processor 360 of the transfer module 330 processes the header of each data frame transferred between the plurality of internal network relay devices 300 included in the network relay system 30.

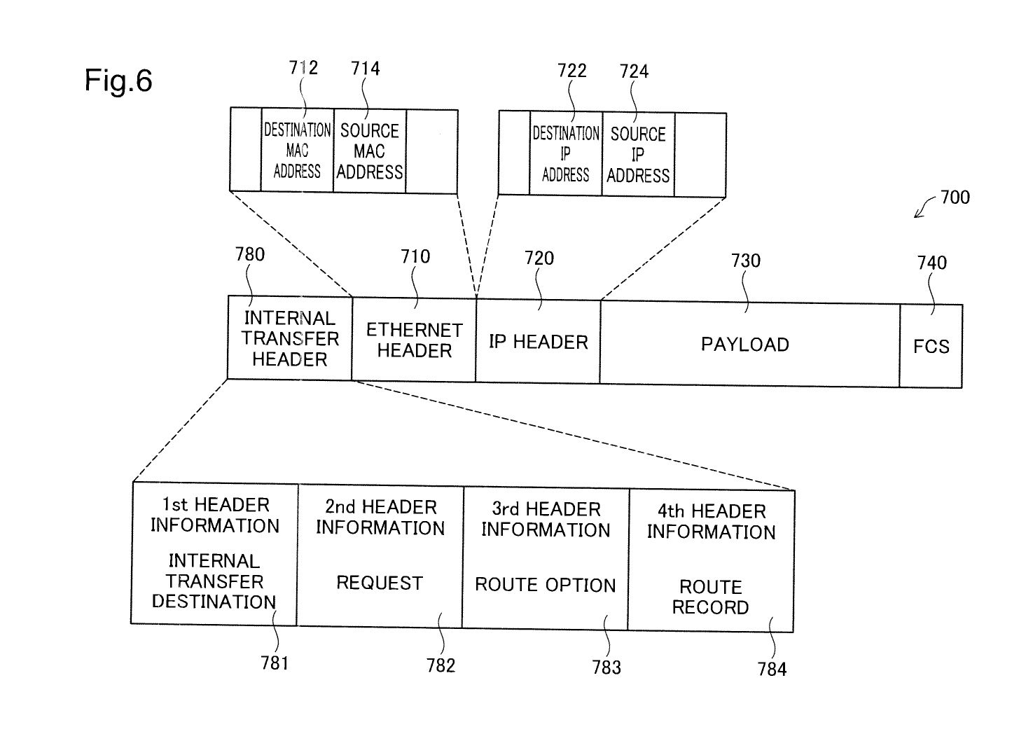

FIG. 6 is a schematic explanatory diagram showing the frame structure 700 of a data frame to be transferred between the plurality of internal network relay devices 300. The frame structure 700 includes an internal transfer header 780, an Ethernet header 710, an IP header 720, a payload filed 730 and an FCS (frame check sequence) field 740 in this sequence from the head to the tail. The Ethernet header 710 of the frame structure 700 includes a field 712 for storing the destination MAC address and a field for storing the source MAC address. The IP header 720 of the frame structure 700 includes a field 722 for storing the destination IP address and a field 724 for storing the source IP address.

The internal transfer header 780 of the frame structure 700 is attached to a data frame by the internal header processor 360, when the data frame is transferred between the plurality of internal network relay devices 300. The internal transfer header 780 includes first header information 781, second header information 782, third header information 783 and fourth header information 784.

The first header information 781 of the internal transfer header 780 shows an internal transfer destination or another internal network relay device 300 specified as the transfer destination of the data frame. The first header information 781 may take any header format receivable by another internal network relay device 300, for example, the Ethernet header format and the IP header format in this embodiment, although any other unique header format may be adopted alternatively. The second header information 782 of the internal transfer header 780 shows an instruction or request to be given to the another internal network relay device 300 specified as the transfer destination of the data frame. The third header information 783 of the internal transfer header 780 shows a route option or a candidate for route information to be used for transferring the data frame to the external network 20. The fourth header information 784 of the internal transfer header 780 shows a route record for identifying all the internal network relay devices 300 which the data frame goes through, among the plurality of internal network relay devices 300.

As shown in FIG. 4, the controller 310 includes an information learner 321, an information allocator 322, a space information generator 323 and an information registrator 324 as the functional blocks implemented through the operations of the CPU 311 according to the control program 320. In this embodiment, one of the plurality of internal network relay devices 300 in the network relay system 30 is specified as a protocol processing device, which enables and performs the functions of the information learner 321, the information allocator 322, the space information generator 323 and the information registrator 324, in parallel to the function as a relay module for relaying the data frame. The internal network relay device 300 specified as the protocol processing device cooperates with the external network to perform various protocol operations.

The information learner 321 of the controller 310 serves as a route learner to learn multiple pieces of route information representing transfer destination IP addresses of the data frame from the network relay system 30 to the external network 20. The route information learnt by the information learner 321 correlates the transfer destination in the route from the network relay system 30 toward the external network 20 to the IP address range representing an allocation range of the destination IP address of the data frame.

In this embodiment, the information learner 321 also serves as an ARP learner and a source address learner, in addition to the route learner. The ARP learner function of the information learner 321 learns multiple pieces of address resolution protocol (ARP) information correlated to destination MAC (media access control) addresses as the destination addresses of the data link layer with regard to each of the transfer destination IP addresses correlated as the transfer destinations to the IP address ranges in the multiple pieces of route information. The source address learner function of the information learner 321 learns multiple pieces of source address information, which correlate the source MAC address of the data frame received by the internal network relay device 300 and the network interface receiving the data frame to the destination MAC address of the data frame as the object to be transferred and the output network interface or the network interface to be used for outputting the data frame. The multiple pieces of source address information are used to search the destination MAC addresses of the ARP information for the output network interface. In this embodiment, the multiple pieces of source address information include the MAC addresses of the output network interfaces as the source MAC addresses.

The information allocator 322 of the controller 310 serves as a route allocator to create a plurality of allocation route tables 352 respectively corresponding to the plurality of internal network relay devices 300 included in the network relay system 30. The multiple pieces of route information learnt by the information learner 312 are allocated in units of the route information to the plurality of allocation route tables 352 created by the information allocator 322.

In this embodiment, the information allocator 322 also serves as an ARP allocator and a source address allocator, in addition to the route allocator. The ARP allocator function of the information allocator 322 creates a plurality of ARP tables 355, to which the multiple pieces of ARP information learnt by the ARP learner function of the information learner 321 are allocated in units of the ARP information according to the allocation of the multiple pieces of route information to the plurality of allocation route tables 352. The source address allocator function of the information allocator 322 creates a plurality of source address tables 356, to which the multiple pieces of source address information learnt by the source address learner function of the information learner 321 are allocated in units of the source address information according to the allocation of the multiple pieces of ARP information to the plurality of ARP tables 355.

The space information generator 323 of the controller 310 generates address space information representing the correlation of the IP addresses on the IP address space between the multiple pieces of route information respectively allocated to the plurality of allocation route tables 352. In this embodiment, the address space information generated by the space information generator 323 is correlated to each of the multiple pieces of route information allocated to the plurality of allocation route tables 352. The address space information shows whether route information of an IP address range belonging to a common IP address space and having a longer prefix length is allocated to any other allocation route table 352 among the plurality of allocation route tables 352.

The information registrator 324 of the controller 310 serves as a route registrator to register the plurality of allocation route tables 352 with the address space information correspondingly into the plurality of internal network relay devices 300. Each of the plurality of internal network relay devices 300 having the corresponding allocation route table 352 registered by the information registrator 324 transfers the data frame, based on the allocation route table 352 and the address space information registered in the self-device by the information registrator 324.

In this embodiment, the information registrator 324 also serves as an ARP registrator and a source address registrator, in addition to as the route registrator. The ARP registrator function of the information registrator 324 registers the plurality of ARP tables 355 correspondingly into the plurality of internal network relay devices 300. The source address registrator function of the information registrator 324 registers the plurality of source address tables 356 correspondingly into the plurality of internal network relay devices 300.

A2. Operations of Computer Network

A2-1. Protocol Processing Device Specification Process

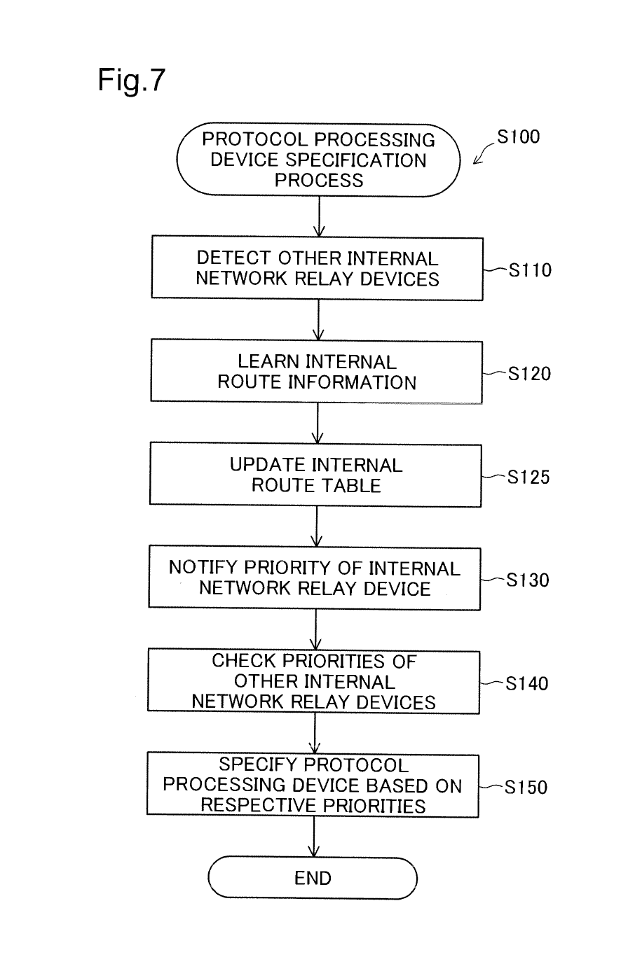

FIG. 7 is a flowchart showing a protocol processing device specification process (step S100) performed by the controller 310 in each of the internal network relay devices 300. The protocol processing device specification process (step S100) specifies the internal network relay device 300 to be used as the protocol processing device, among the plurality of internal network relay devices 300 included in the network relay system 30. In this embodiment, the protocol processing device specification process (step S100) is implemented through the operations of the CPU 311 of the controller 310 according to the control program 320. In this embodiment, every time an internal network relay device 300 is added to or deleted from the network relay system 30, the controller 310 in each of the plurality of internal network relay devices 300 starts the protocol processing device specification process (step S100).

On the start of the protocol processing device specification process (step S100), the controller 310 of each internal network relay device 300 refers to the settings information 329 stored in the storage module 312 and detects the presence of all the other internal network relay devices 300 (step S110). The controller 310 then learns the internal route information used for communication with each of the other internal network relay devices 300 (step S120). In this embodiment, the controller 310 statistically learns the internal route information, based on the settings information 329 stored in the storage module 312. In another embodiment, the controller 310 may dynamically learn the internal route information according to a routing protocol. After learning the internal route information (step S120), the controller 310 updates the internal route table 353 stored in the storage module 350, based on the learnt internal route information (step S125).

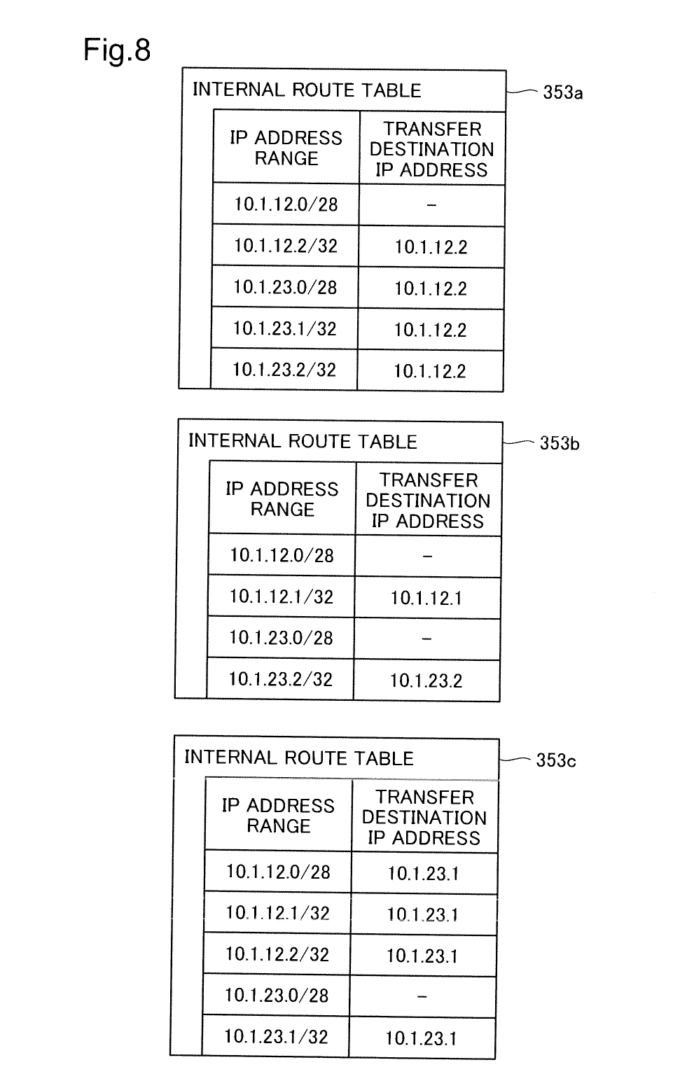

FIG. 8 is an explanatory diagram showing the internal route tables 353. Each of the internal route tables 353 stores the IP address range as the IP route used for communication between the internal network relay devices 300, in correlation to the transfer destination IP address (next hop) used for transferring the data frame to the correlated IP address range.

In the description of this embodiment, the internal route table is generally represented by the numerical symbol “353”, and a specific internal route table is represented by the numerical symbol “353” with a suffix of an alphabetical letter corresponding to the alphabetical letter allocated to the internal network relay device 300 having the internal route table. In the illustrated example of FIG. 8, the internal network relay device 300a has an internal route table 353a. Similarly the internal network relay device 300b has an internal route table 353b, and the internal network relay device 300c has an internal route table 353c.

Referring back to the flowchart of FIG. 7, after updating the internal route table 353 (step S125), the controller 310 of each internal network relay device 300 refers to the contents of the internal route table 353 and notifies the other internal network relay devices 300 of the priority of the self-device 300 (step S130). In this embodiment, the priorities of the plurality of internal network relay devices 300 are provided in advance in the form of settings information 329. The priority order decreases in the sequence of the internal network relay device 300a, the internal network relay device 300b, and the internal network relay device 300c.

After notifying the other internal network relay devices 300 of the priority of the self-device 300 (step S130), the controller 310 of the internal network relay device 300 checks the notified priorities of the other internal network relay devices 300 (step S140). The controller 310 then specifies one internal network relay device 300 to be used as the protocol processing device, based on the respective priorities of the plurality of internal network relay devices 300 (step S150). In this embodiment, a single internal network relay device 300 is specified commonly as the protocol processing device. The internal network relay device 300 specified as the protocol processing device cooperates with the external network 20 to perform various protocol operations. In another embodiment, different internal network relay devices 300 may be specified as the protocol processing device for different protocol operations.

A2-2. Transfer Preparation Process

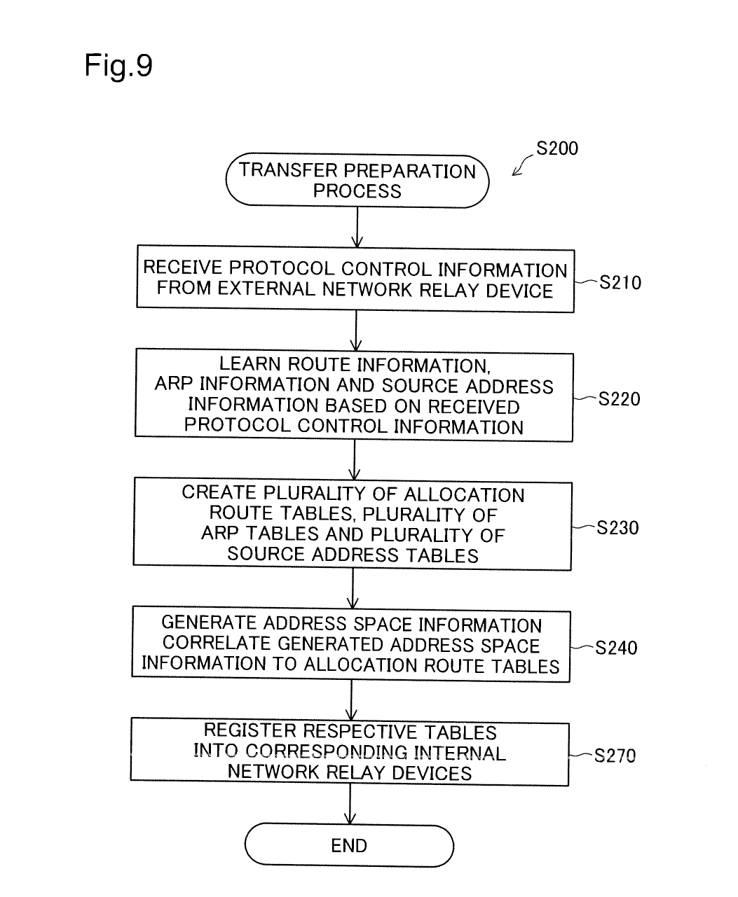

FIG. 9 is a flowchart showing a transfer preparation process (step S200) performed by the controller 310 of the internal network relay device 300 specified as the protocol processing device. The transfer preparation process (step S200) provides each of the plurality of internal network relay devices 300 with a corresponding allocation route table 352, a corresponding ARP table 355 and a corresponding source address table 356. In this embodiment, the transfer preparation process (step S200) is implemented through the operations of the CPU 311 of the controller 310 according to the control program 320. In this embodiment, in response to reception of protocol control information or control information regarding the communication protocol from the external network 20, the controller 310 of the internal network relay device 300 specified as the protocol processing device by the protocol processing device specification process (step S100) starts the transfer preparation process (step S200).

On the start of the transfer preparation process (step S200), the controller 310 of the specified internal network relay device 300 receives the protocol control information from the external network relay device 200 of the external network 20 (step S210). In this embodiment, in response to reception of protocol control information from the external network relay device 200, each of the internal network relay devices 300 other than that specified as the protocol processing device transfers the received protocol control information to the internal network relay device 300 specified as the protocol processing device. After receiving the protocol control information (step S210), the controller 310 of the internal network relay device 300 specified as the protocol processing device serves as the information learner 321 to learn the route information, the ARP information and the source address information, based on the received protocol control information and relevant pieces of known information and generate learnt route information 391, learnt ARP information 392 and learnt source address information 393 (step S220).

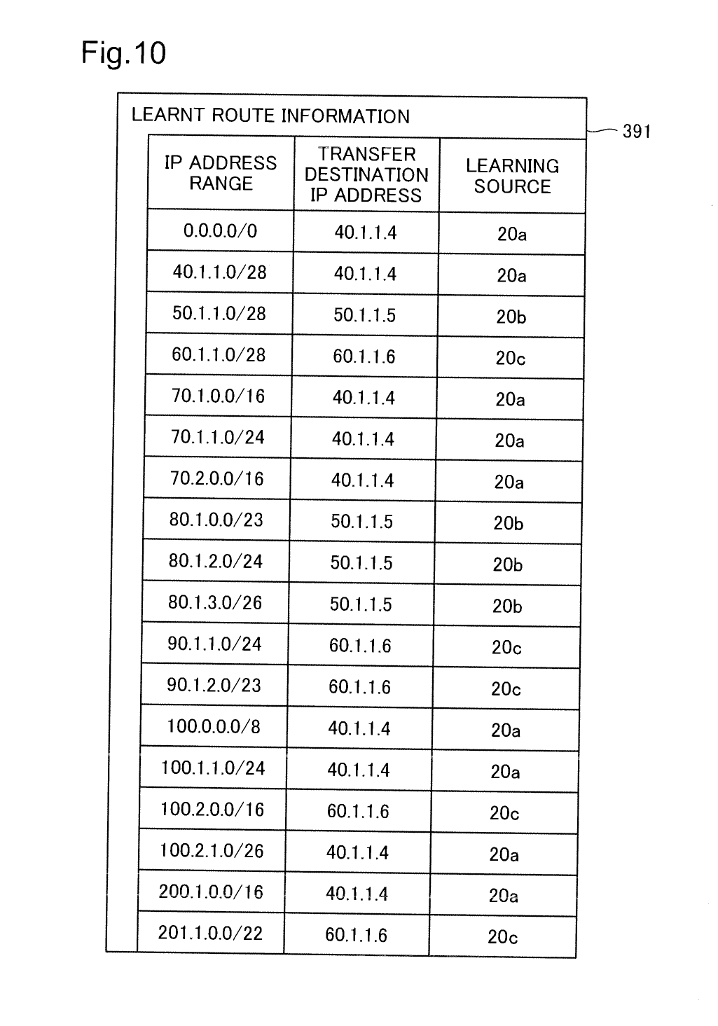

FIG. 10 is an explanatory diagram showing the learnt route information 391. The controller 310 learns the route information based on the received protocol control information, so as to generate learnt route information 391. The learnt route information 391 includes the IP address range representing the IP route from the network relay system 30 to the external network 20, and the transfer destination IP address (next hop) used for transferring the data frame to the IP address range. The third column of FIG. 10 is “learning source” column showing a symbol for identifying the network interface of the external network relay device 200 as the learning source of each piece of route information.

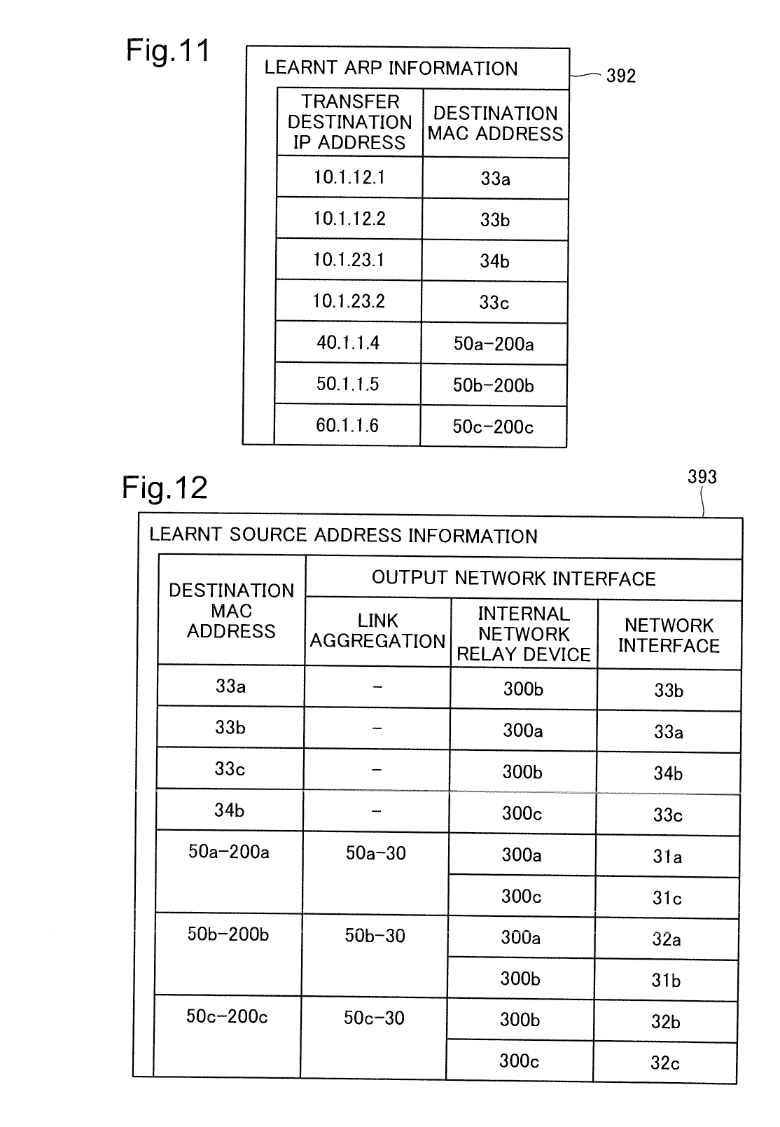

FIG. 11 is an explanatory diagram showing the learnt ARP information 392. The controller 310 learns the ARP information based on the received protocol control information, so as to generate learnt ARP information 392. The learnt ARP information 392 includes the transfer destination IP address included in the learnt route information 391 and the internal route table 353, and the destination MAC address correlated to the transfer destination IP address.

In the description of this embodiment, the MAC address is represented by the symbol of the network interface identified by the MAC address. For example, the MAC address of the network interface 33a is represented by the symbol “33a”, and the MAC address of the network interface 34b is represented by the symbol “34b”. The symbol “50a-200a” is used to represent the network interface on the side of the external network relay device 200a in the link aggregation 50a, and the symbol “50a-30” is used to represent the network interface on the side of the network relay system 30 in the link aggregation 50a.

FIG. 12 is an explanatory diagram showing the learnt source address information 393. The controller 310 learns the source address information based on the received protocol control information, so as to generate learnt source address information 393. The learnt source address information 393 includes the destination MAC address included in the learnt ARP information 392, and the output network interface correlated to the destination MAC address. In this embodiment, the learnt source address information 393 includes the MAC address of the output network interface, as well as information representing the link aggregation 50 including the output network interface and the internal network relay device 300, as the information for identifying the output network interface.

Referring back to the flowchart of FIG. 9, after generating the learnt route information 391, the learnt ARP information 392 and the learnt source address information 393 (step S220), the controller 310 serves as the information allocator 322 to create a plurality of allocation route tables 352, a plurality of ARP tables 355 and a plurality of source address tables 356 corresponding to the respective internal network relay devices 300 (step S230). The controller 310 then serves as the space information generator 323 to generate the address space information and correlate the generated address space information to the plurality of allocation route tables 352 (step S240). The address space information specifies the correlation of the IP address ranges on the IP address space between the multiple pieces of route information respectively allocated to the plurality of allocation route tables 352. In this embodiment, the address space information shows whether route information of an IP address range belonging to a common IP address space and having a longer prefix length is allocated to any other allocation route table 352 among the plurality of allocation route tables 352. After correlating the address space information to the allocation route tables 352 (step S240), the controller 310 serves as the information registrator 324 to register the plurality of allocation route tables 352, the plurality of ARP tables 355 and the plurality of source address tables 356 correspondingly into the plurality of internal network relay devices 300 (step S270).

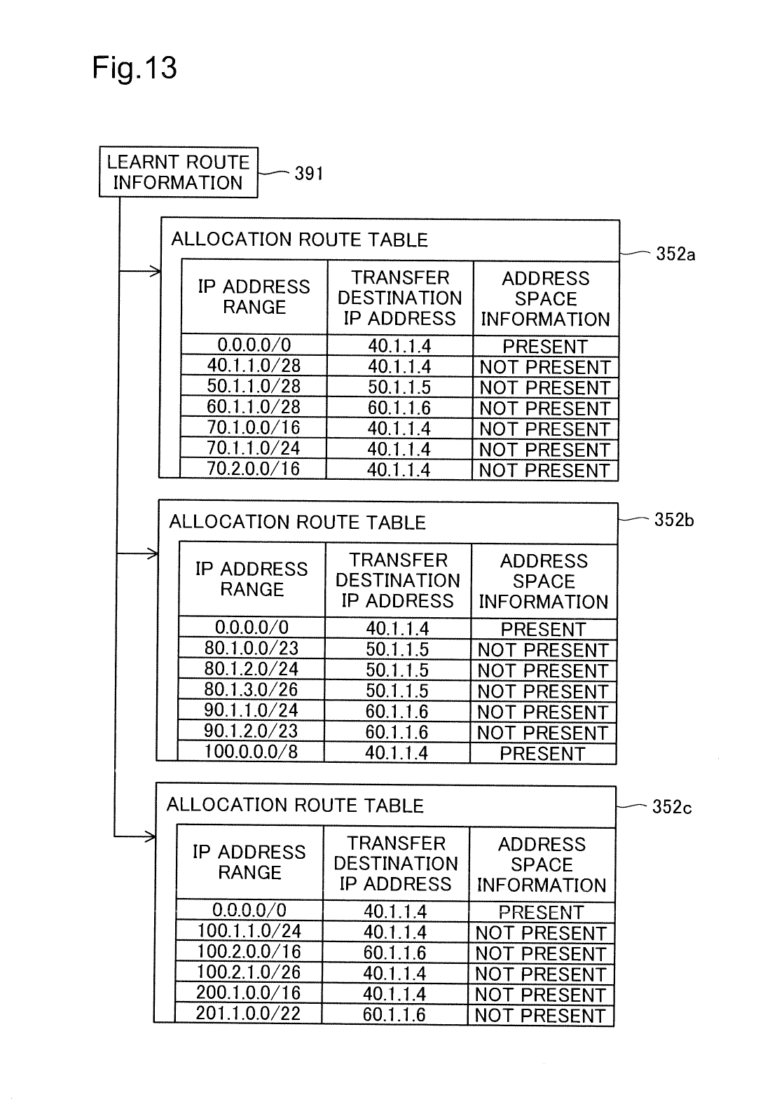

FIG. 13 is an explanatory diagram showing the allocation route tables 352. Multiple pieces of route information in the learnt route information 391 are allocated in units of the route information to the plurality of allocation route tables 352 and are correlated to the address space information. In this embodiment, the multiple pieces of route information in the learnt route information 391 are allocated to the plurality of allocation route tables 352, such that substantially equal numbers of pieces of route information are allocated to the respective allocation route tables 352.

In the description of this embodiment, the allocation route table is generally represented by the numerical symbol “352”, and a specific allocation route table is represented by the numerical symbol “352” with a suffix of an alphabetical letter corresponding to the alphabetical letter allocated to the internal network relay device 300 corresponding to the allocation route table. In the illustrated example of FIG. 13, an allocation route table 352a corresponds to the internal network relay device 300a. Similarly an allocation route table 352b corresponds to the internal network relay device 300b, and an allocation route table 352c corresponds to the internal network relay device 300c.

In this embodiment, route information of an IP address range “0.0.0.0/0” is set as common route information commonly allocated to the plurality of allocation route tables 352. With regard to this route information of the IP address range “0.0.0.0/0”, route information of an IP address range belonging to the common IP address space and having a longer prefix length is present in another allocation route table 352. The address space information representing “present” is thus correlated to the route information of the IP address range “0.0.0.0/0”.

With regard to route information of an IP address range “100.0.0.0/8” allocated to the allocation route table 352b, pieces of route information of IP address ranges “100.1.1.0/24”, “100.2.0.0/16” and “100.2.1.0/26” belonging to the common IP address space and having longer prefix lengths are present in the allocation route table 352c. The address space information representing “present” is thus correlated to the route information of the IP address range “100.0.0.0/8”.

With regard to route information other than the route information of the IP address range “0.0.0.0/0” and the route information of the IP address range “100.0.0.0/8”, no route information of an IP address range belonging to the common IP address space and having a longer prefix length is present in any other allocation route table 352. The address space information representing “not present” is thus correlated to these other pieces of route information. With regard to route information of an IP address range “70.1.0.0/16” allocated to the allocation route table 352a, route information of an IP address range “70.1.1.0/24” belonging to the common IP address space and having a longer prefix length is present but is allocated to the same allocation route table 352a. The address space information representing “not present” is thus correlated to the route information of the IP address range “70.1.0.0/16”.

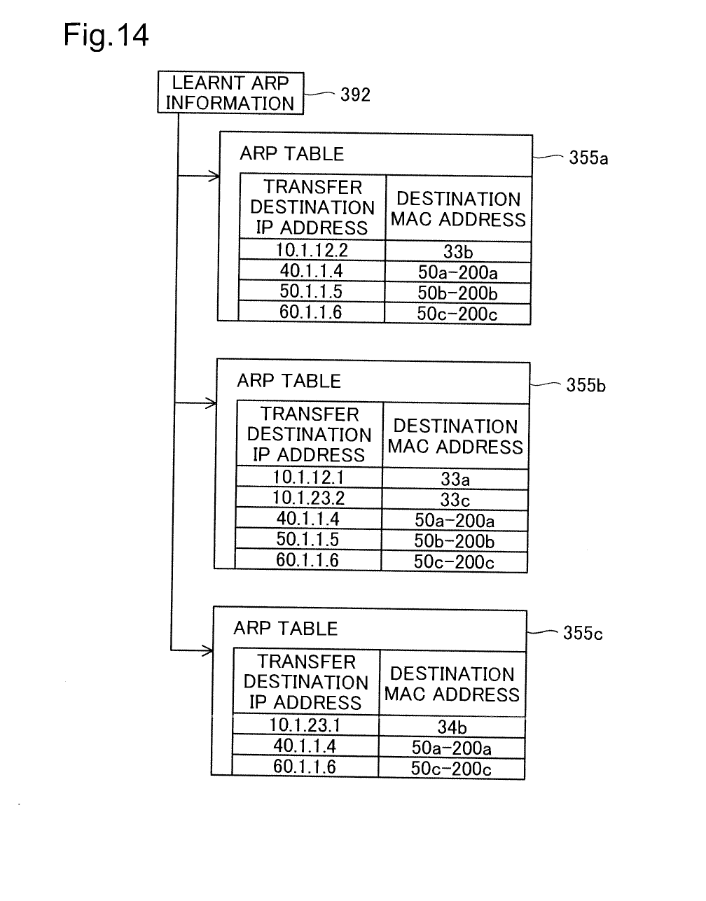

FIG. 14 is an explanatory diagram showing the ARP tables 355. Multiple pieces of ARP information in the learnt ARP information 392 are allocated to the plurality of ARP tables 355 according to the corresponding allocation route tables 352. In the description of this embodiment, the ARP table is generally represented by the numerical symbol “355”, and a specific ARP table is represented by the numerical symbol “355” with a suffix of an alphabetical letter corresponding to the alphabetical letter allocated to the internal network relay device 300 corresponding to the ARP table. In the illustrated example of FIG. 14, an ARP table 355a corresponds to the internal network relay device 300a. Similarly an ARP table 355b corresponds to the internal network relay device 300b, and an ARP table 355c corresponds to the internal network relay device 300c.

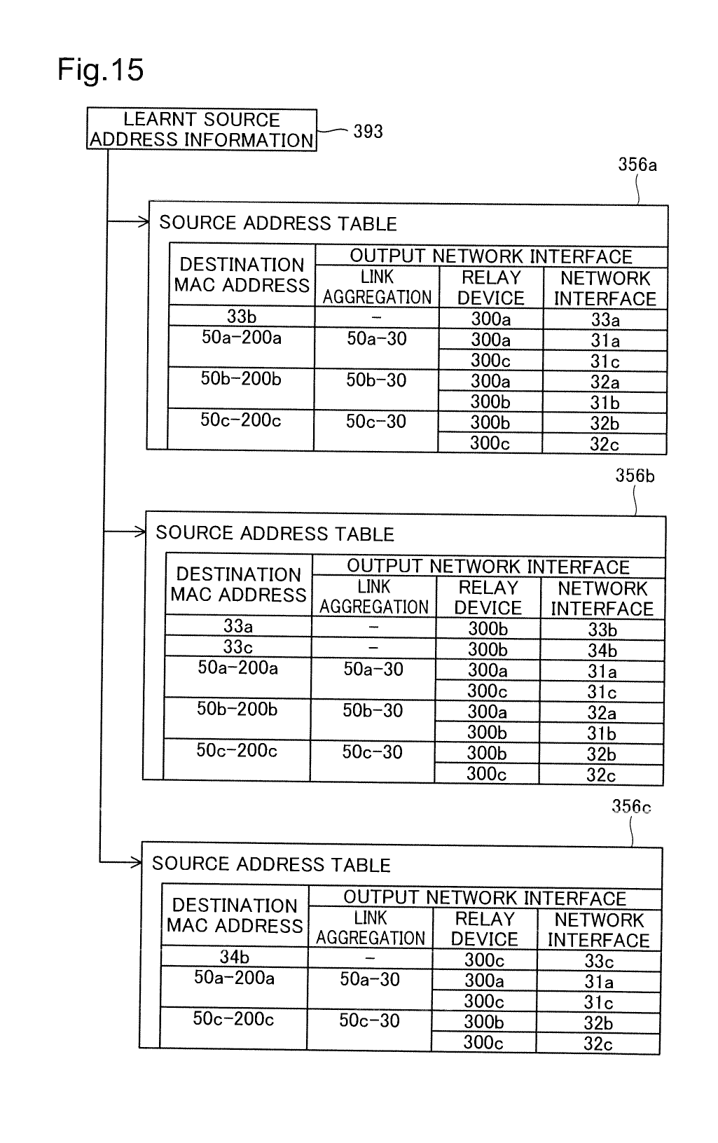

FIG. 15 is an explanatory diagram showing the source address tables 356. Multiple pieces of source address information in the learnt source address information 393 are allocated to the plurality of source address tables 356 according to the corresponding ARP tables 355. In the description of this embodiment, the source address table is generally represented by the numerical symbol “356”, and a specific source address table is represented by the numerical symbol “356” with a suffix of an alphabetical letter corresponding to the alphabetical letter allocated to the internal network relay device 300 corresponding to the source address table. In the illustrated example of FIG. 15, a source address table 356a corresponds to the internal network relay device 300a. Similarly a source address table 356b corresponds to the internal network relay device 300b, and a source address table 356c corresponds to the internal network relay device 300c.

A2-3. Transfer Process

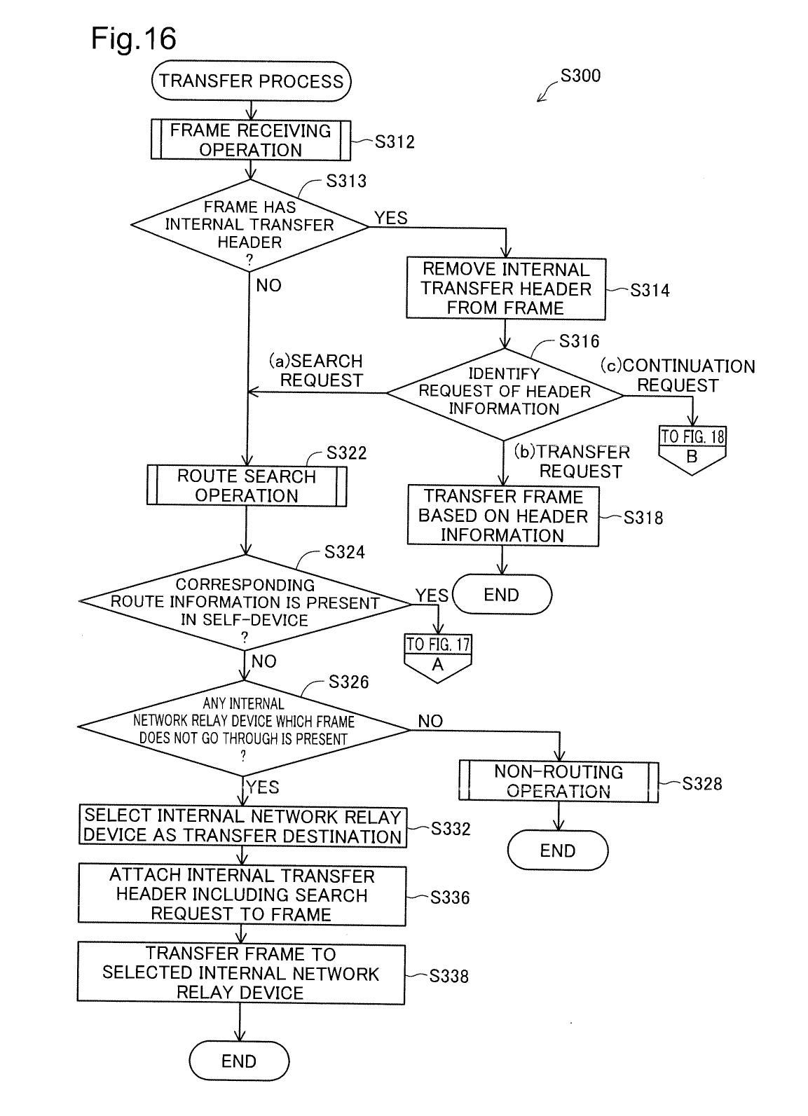

FIGS. 16, 17 and 18 are flowcharts showing a transfer process (step S300) performed by the transfer module 330 of the internal network relay device 300. The transfer process (step S300) relays the data frame. In this embodiment, the transfer process (step S300) is implemented through the operations of the search module 340 and the internal header processor 360 of the transfer module 330 based on the respective electric circuit structures.

In another embodiment, at least part of the functions of the transfer process (step S300) may be implemented through the operations of the CPU according to a program. In this embodiment, the transfer module 330 starts the transfer process (step S300), when the interface module 380 receives a data frame.

Referring to the flowchart of FIG. 16, on the start of the transfer process (step S300), the transfer module 330 of the internal network relay device 300 performs a frame receiving operation (step S312). The frame receiving operation (step S312) performed by the transfer module 330 receives the data frame from the interface module 380 and analyzes the header information attached to the received data frame.

After performing the frame receiving operation (step S312), the transfer module 330 determines whether the received data frame has the internal transfer header 780 (step S313). In this embodiment, when the internal network relay device 300 receives a data frame from the external network relay device 200, the received data frame does not have the internal transfer header 780. When the internal network relay device 300 receives a data frame from another internal network relay device 300, on the other hand, the received data frame has the internal transfer header 780.

When the received data frame does not have the internal transfer header 780, i.e., when the data frame is received from the external network relay device 200 (step S313: No), the transfer module 330 serves as a route searcher to perform a route search operation (step S322). The route search operation (step S322) performed by the transfer module 330 searches the allocation route table 352 stored in the storage module 350 of the self-device 300 for route information corresponding to the received data frame. More specifically, the transfer module 330 refers to the destination IP address of the IP header 720 attached to the received data frame and searches the allocation route table 352 registered in the storage module 350 of the self-device 300 for the route information in the IP address range corresponding to the destination IP address.

When no corresponding route information is detected as the result of the route search operation (step S322) (step S324: No), the transfer module 330 determines whether there is any internal network relay device 300 which the data frame received by the frame receiving operation (step S312) does not go through (step S326). In this embodiment, when the received data frame does not have the internal transfer header 780, the transfer module 330 determines the presence of any internal network relay device 300 which the received data frame does not go through. When the received data frame has the internal transfer header 780, the transfer module 330 determines the presence of any internal network relay device 300 which the received data frame does not go through, based on the fourth header information 784 included in the internal transfer header 780.

In the absence of any internal network relay device 300 which the received data frame does not go through, i.e., when none of the internal network relay devices 300 has the corresponding route information (step S326: No), the transfer module 330 performs a non-routing operation (step S328). In this embodiment the non-routing operation (step S328) performed by the transfer module 330 notifies the sender of the data frame of failed relay of the data frame.

In the presence of any internal network relay device 300 which the received data frame does not go through (step S326: Yes), on the other hand, the transfer module 330 selects one of such internal network relay devices 300 which the received data frame does not go through, as a transfer destination (step S332). In this embodiment, the transfer destination is selected among the internal network relay devices 300 which the received data frame does not go through, based on the priorities set in advance in the respective internal network relay devices 300. The criterion of selection is, however, not limited to the priority order. In other embodiments, the transfer destination may be selected according to a specified device number or may be selected at random.

After selecting another internal network relay device 300 as the transfer destination (step S332), the transfer module 330 serves as an instruction adder to add the internal transfer header 780 including a search request to the data frame (step S336). More specifically, the transfer module 330 stores an identifier identifying the another internal network relay device 300 selected as the transfer destination, as the first header information 781 of the internal transfer header 780, while storing an identifier representing a search request that gives an instruction for route search to the another internal network relay device 300 selected as the transfer destination, as the second header information 782 of the internal transfer header 780. The transfer module 330 further stores an identifier representing absence of any candidate for route information, as the third header information 783 and identifiers identifying all the internal network relay devices 300 including the self-device 300 which the data frame goes through, as the fourth header information 784, in addition to the first header information 781 and the second header information 782 of the internal transfer header 780.

After attaching the internal transfer header 780 to the data frame (step S336), the transfer module 330 transfers the data frame with the attached internal transfer header 780 to the another internal network relay device 300 selected as the transfer destination, based on the contents of the internal route table 353 stored in the storage module 350 of the self-device 300 (step S338).

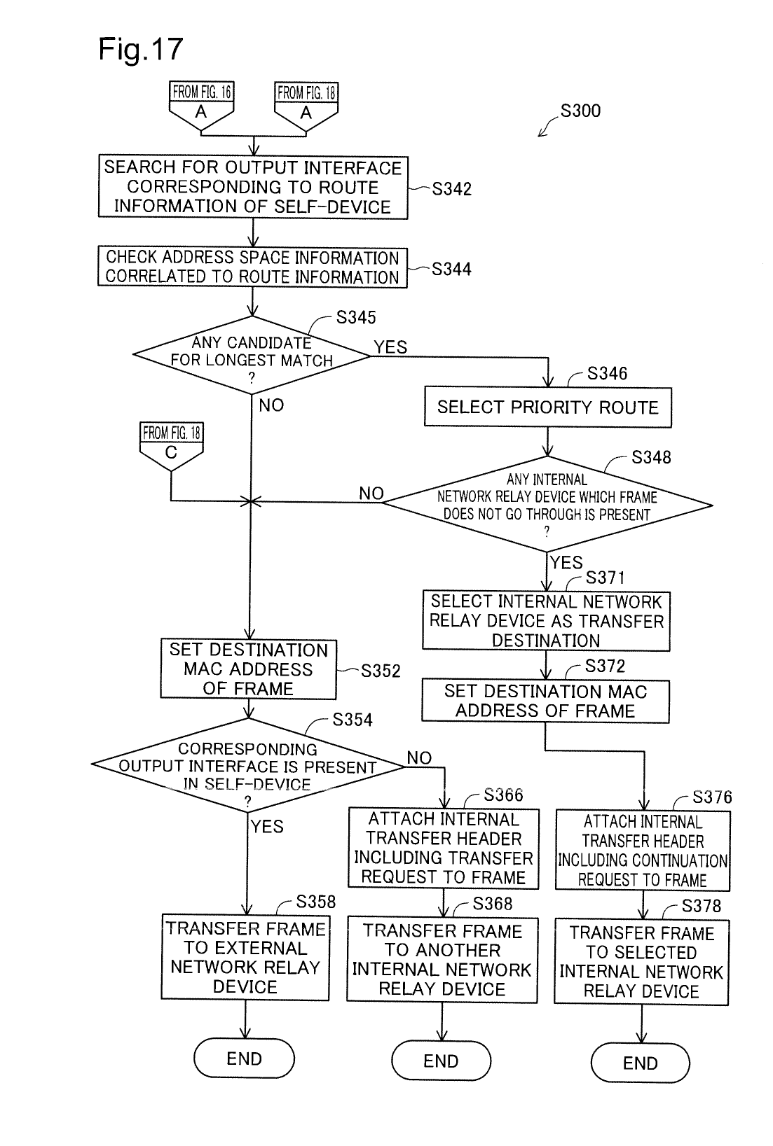

When the corresponding route information is detected as the result of the route search operation (step S322) (step S324: Yes), the processing flow goes to FIG. 17. The transfer module 330 then searches for an output network interface corresponding to the detected route information of the self-device 300 (step S342). More specifically, the transfer module 330 searches the ARP table 355 of the self-device 300 for a destination MAC address corresponding to the transfer destination IP address (next hop) of the route information detected from the allocation route table 352 of the self-device 300. The transfer module 330 then searches the source address table 356 of the self-device 300 for an output network interface corresponding to the destination MAC address detected from the ARP table 355 of the self-device 300.

After searching for the corresponding output network interface (step S342), the transfer module 330 refers to the allocation route table 352 of the self-device 300 and checks the address space information correlated to the route information detected by the route search operation (step S322) (step S344). More specifically, the transfer module 330 determines whether route information in an IP address range belonging to the common IP address space and having a longer prefix length is allocated to any other internal network relay device 300. When the address space information represents “present”, the transfer module 330 determines that there is any candidate for longest match or any candidate for route information, which is subjected to longest match analysis based on the relation to the route information detected by the route search operation (step S322), in any other internal network relay device 300. When the address space information represents “not present”, on the other hand, the transfer module 330 determines that there is no candidate for longest match in any other internal network relay device 300.

When there is no candidate for longest match (step S345: No), the transfer module 330 changes the destination MAC address of the Ethernet header 710 attached to the data frame to the destination MAC address of the ARP information corresponding to the route information of the self-device 300 detected by the route search operation (step S322) (step S352). The transfer module 330 then determines whether an output network interface corresponding to the route information of the self-device 300 detected by the route search operation (step S322) is present in the self-device 300 (step S354).

When the corresponding output network interface is present in the self-device 30 (step S354: Yes), the transfer module 330 changes the source MAC address of the Ethernet header 710 attached to the data frame to the MAC address of the corresponding output network interface and transfers the data frame from the corresponding output network interface of the self-device 300 to the external network relay device 200 (step S358).

When the corresponding output network interface is not present in the self-device 30 (step S354: No), on the other hand, the transfer module 330 serves as the instruction adder to add the internal transfer header 780 including a transfer request to the data frame (step S366). More specifically, the transfer module 330 stores an identifier identifying another internal network relay device 300 having the corresponding output network interface, as the first header information 781 of the internal transfer header 780, while storing an identifier representing a transfer request that gives an instruction to transfer the data frame to the another internal network relay device 300 having the corresponding output network interface, as the second header information 782 of the internal transfer header 780. The transfer module 330 further stores an identifier identifying the corresponding output network interface, as the third header information 783 and identifiers identifying all the internal network relay devices 300 including the self-device 300 which the data frame goes through, as the fourth header information 784, in addition to the first header information 781 and the second header information 782 of the internal transfer header 780.

After attaching the internal transfer header 780 to the data frame (step S366), the transfer module 330 transfers the data frame with the attached internal transfer header 780 to the another internal network relay device 300 having the corresponding output network interface, based on the contents of the internal route table 353 stored in the storage module 350 of the self-device 300 (step S368).

When there is any candidate for longest match (step S345: Yes), the transfer module 330 selects route information having a longest prefix length as a priority route, among the multiple pieces of route information detected in the plurality of internal network relay devices 300 (step S346). The transfer module 330 checks the route information detected in another internal network relay device 300, based on the third header information 783 of the internal transfer header 780 attached to the data frame received from another internal network relay device 300. When there is no route information detected in any other internal network relay device 300, the transfer module 330 selects the route information detected in the self-device 300 as the priority route.

After selecting the priority route (step S346), the transfer module 330 determines whether there is any internal network relay device 300 which the data frame received by the frame receiving operation (step S312) does not go through (step S348). In this embodiment, when the received data frame does not have the internal transfer header 780, the transfer module 330 determines the presence of any internal network relay device 300 which the received data frame does not go through. When the received data frame has the internal transfer header 780, the transfer module 330 determines the presence of any internal network relay device 300 which the received data frame does not go through, based on the fourth header information 784 included in the internal transfer header 780.

In the absence of any internal network relay device 300 which the received data frame does not go through (step S348: No), the transfer module 330 uses the route information selected as the priority route and performs rewriting the destination AMC address of the data frame (step S352) and the subsequent processing.

In the presence of any internal network relay device 300 which the received data frame does not go through (step S348: Yes), on the other hand, the transfer module 330 selects one of such internal network relay devices 300 which the received data frame does not go through, as a transfer destination (step S371). In this embodiment, the transfer destination is selected among the internal network relay devices 300 which the received data frame does not go through, based on the priorities set in advance in the respective internal network relay devices 300. The criterion of selection is, however, not limited to the priority order. In other embodiments, the transfer destination may be selected according to a specified device number or may be selected at random.

After selecting another internal network relay device 300 as the transfer destination (step S371), the transfer module 330 changes the destination MAC address of the Ethernet header 710 attached to the data frame to the destination MAC address of the ARP information corresponding to the route information selected as the priority route (step S372).

After rewriting the destination MAC address of the data frame (step S372), the transfer module 330 serves as the instruction adder to add the internal transfer header 780 including a continuation request to the data frame (step S376). More specifically, the transfer module 330 stores an identifier identifying the another internal network relay device 300 selected as the transfer destination, as the first header information 781 of the internal transfer header 780, while storing an identifier representing a continuation request that gives an instruction for continuous route search to the another internal network relay device 300 selected as the transfer destination, as the second header information 782 of the internal transfer header 780. The transfer module 330 further stores identifiers representing the route information selected as the priority route, the corresponding ARP information and the corresponding output network interface, as the third header information 783 and identifiers identifying all the internal network relay devices 300 including the self-device 300 which the data frame goes through, as the fourth header information 784, in addition to the first header information 781 and the second header information 782 of the internal transfer header 780.

After attaching the internal transfer header 780 to the data frame (step S376), the transfer module 330 transfers the data frame with the attached internal transfer header 780 to the another internal network relay device 300 selected as the transfer destination, based on the contents of the internal route table 353 stored in the storage module 350 of the self-device 300 (step S378).

Referring back to the flowchart of FIG. 16, when the received data frame has the internal transfer header 780, i.e., when the data frame is received from another internal network relay device 300 (step S313: Yes), the transfer module 330 removes the internal transfer header 780 from the data frame received by the frame receiving operation (step S312) (step S314). The transfer module 330 then analyzes the identifier stored as the second header information 782 of the internal transfer header 780 removed from the received data frame (step S316).

When the analyzed identifier of the second header information 782 of the internal transfer header 780 represents a search request (step S316: “a”), the transfer module 330 performs the route search operation (step S322) and the subsequent processing with regard to the data frame after removal of the internal transfer header 780.

When the analyzed identifier of the second header information 782 of the internal transfer header 780 represents a transfer request (step S316: “b”), the transfer module 330 transfers the received data frame from the output network interface of the self-device 300 to the external network relay device 200, based on the third header information 783 of the internal transfer header 780 removed from the received data frame (step S318).

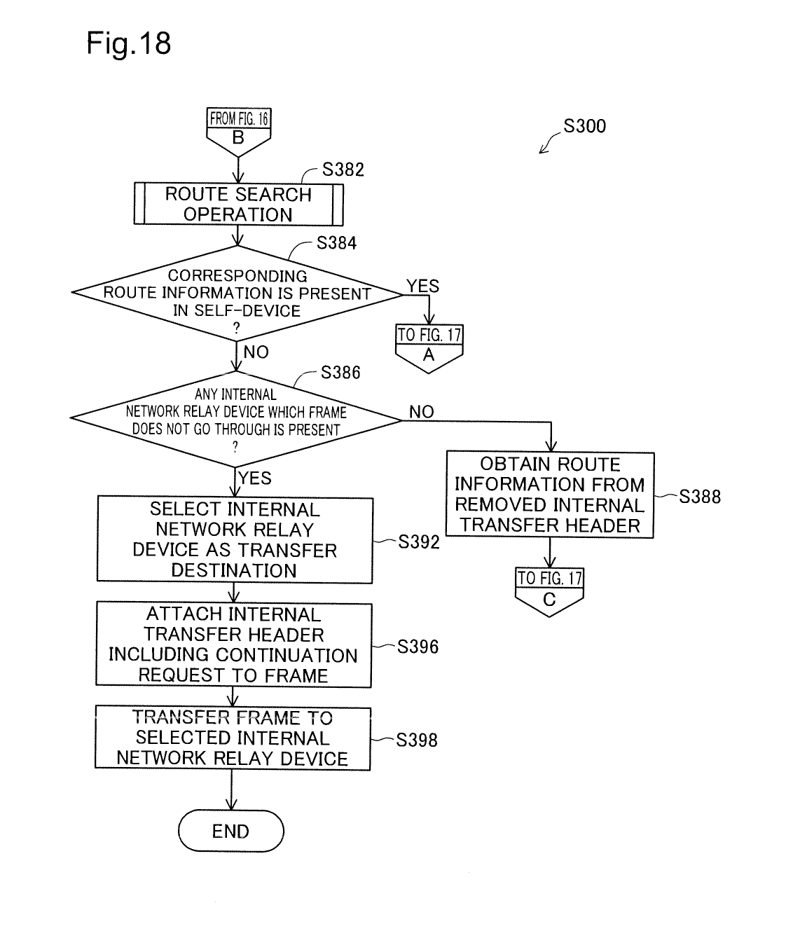

When the analyzed identifier of the second header information 782 of the internal transfer header 780 represents a continuation request (step S316: “c”), the transfer module 330 serves as the route searcher to perform a route search operation (step S382) in the flowchart of FIG. 18. The details of the route search operation (step S382) are identical with those of the route search operation (step S322) described above.

When the corresponding route information is detected as the result of the route search operation (step S382) (step S384: Yes), the transfer module 330 performs searching for the output network interface corresponding to the detected route information of the self-device 300 (step S342) and the subsequent processing.

When no corresponding route information is detected as the result of the route search operation (step S382) (step S384: No), the transfer module 330 determines whether there is any internal network relay device 300 which the data frame received by the frame receiving operation (step S312) does not go through (step S386).

In the absence of any internal network relay device 300 which the received data frame does not go through (step S386: No), the transfer module 330 obtains the route information stored as the third header information of the internal transfer header 780 removed from the received data frame (step S388) and uses the obtained route information and performs rewriting the destination AMC address of the data frame (step S352) and the subsequent processing.

In the presence of any internal network relay device 300 which the received data frame does not go through (step S386: Yes), on the other hand, the transfer module 330 selects one of such internal network relay devices 300 which the received data frame does not go through, as a transfer destination (step S392). In this embodiment, the transfer destination is selected among the internal network relay devices 300 which the received data frame does not go through, based on the priorities set in advance in the respective internal network relay devices 300. The criterion of selection is, however, not limited to the priority order. In other embodiments, the transfer destination may be selected according to a specified device number or may be selected at random.

After selecting another internal network relay device 300 as the transfer destination (step S392), the transfer module 330 serves as the instruction adder to add the internal transfer header 780 including a continuation request to the data frame (step S396). More specifically, the transfer module 330 stores an identifier identifying the another internal network relay device 300 selected as the transfer destination, as the first header information 781 of the internal transfer header 780, while storing an identifier representing a continuation request that gives an instruction for continuous route search to the another internal network relay device 300 selected as the transfer destination, as the second header information 782 of the internal transfer header 780. The transfer module 330 further stores the route information stored in the removed internal transfer header 780, as the third header information 783 and identifiers identifying all the internal network relay devices 300 including the self-device 300 which the data frame goes through, as the fourth header information 784, in addition to the first header information 781 and the second header information 782 of the internal transfer header 780.

After attaching the internal transfer header 780 to the data frame (step S396), the transfer module 330 transfers the data frame with the attached internal transfer header 780 to the another internal network relay device 300 selected as the transfer destination, based on the contents of the internal route table 353 stored in the storage module 350 of the self-device 300 (step S398).

A2-4. Example of Data Frame Transfer

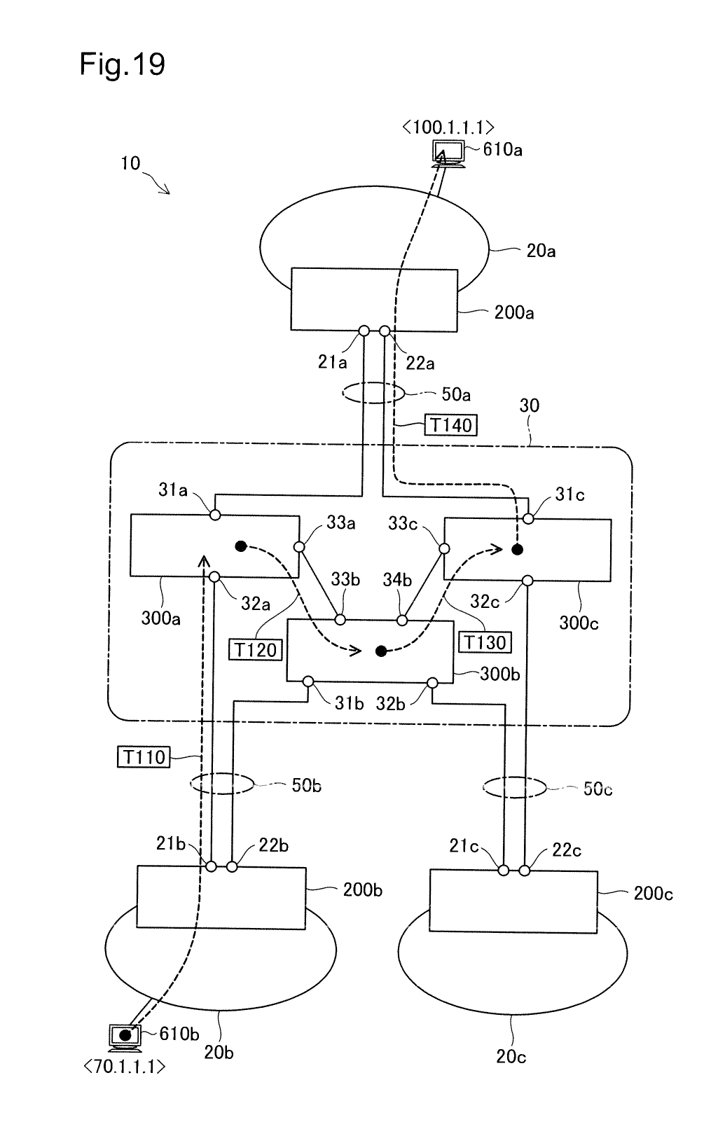

FIG. 19 is an explanatory diagram showing one example of data frame transfer in the first embodiment. In the illustrated example of FIG. 19, a data frame is transferred from the terminal device 610b connecting with the external network 20b to the terminal device 610a connecting with the external network 20a. The terminal device 610b has a set IP address “70.1.1.1”, and the terminal device 610a has a set IP address “100.1.1.1”.

### Transfer Operation T110

The IP address “100.1.1.1” of the terminal device 610a and the IP address “70.1.1.1” of the terminal device 610b are respectively set as the destination IP address and the source IP address in the IP header 720 of the data frame sent from the terminal device 610b. In the illustrated example of FIG. 19, the data frame sent from the terminal device 610b goes through the link aggregation 50b and is transferred to the internal network relay device 300a. A MAC address “50b-30” and a MAC address “50b-200b” are respectively set as the destination MAC address and the source MAC address in the Ethernet header 710 of the data frame going through the network interface 21b of the external network relay device 200b.

### Transfer Operation T120

When the network interface 32a receives the data frame, the internal network relay device 300a searches the allocation route table 352a of the self-device 300a for route information corresponding to the destination IP address “100.1.1.1” of the data frame. There is, however, no corresponding route information in the allocation route table 352a of the self-device 300a. The internal network relay device 300a accordingly selects the internal network relay device 300b as the internal network relay device 300 which the data frame does not go through, and transfers the data frame with the attached internal transfer header 780 to the selected internal network relay device 300b.

The first header information 781 of the internal transfer header 780 attached by the internal network relay device 300a includes an Ethernet header and an IP header. A MAC address “33b” and a MAC address “33a” are respectively set as the destination MAC address and the source MAC address in the Ethernet header of the first header information 781. An IP address “10.1.12.2” and an IP address “10.1.12.1” are respectively set as the destination IP address and the source IP address in the IP Header of the first header information 781.

An identifier representing a search request and an identifier representing absence of any candidate for route information are respectively stored in the second header information 782 and in the third header information 783 of the internal transfer header 780 attached by the internal network relay device 300a. The fourth header information 784 of the internal transfer header 780 is a bitmap consisting of the same number of bits as the number of the internal network relay devices 300. In the illustrated example of FIG. 19, the fourth header information 784 consists of three bits. The internal network relay device 300a, the internal network relay device 300b and the internal network relay device 300c respectively correspond to the first bit, the second bit and the third bit of the fourth header information 784. The internal network relay device 300a enables the first bit of the fourth header information 784 to record that the data frame has gone through the internal network relay device 300a.

### Transfer Operation T130

When the network interface 33b receives the data frame, the internal network relay device 300b removes the internal transfer header 780 attached to the received data frame and checks the second header information 782 of the removed internal transfer header 780. The identifier representing the search request is stored in the second header information 782 of the internal transfer header 780. The internal network relay device 300b accordingly searches the allocation route table 352b of the self-device 300b for route information corresponding to the destination IP address “100.1.1.1” of the received data frame.

The internal network relay device 300b detects route information in an IP address range “100.0.0.0/8” corresponding to the destination IP address “100.1.1.1” of the data frame from the allocation route table 352b of the self-device 300b. The internal network relay device 300b refers to a destination IP address “40.1.1.4” correlated to the detected route information in the IP address range “100.0.0.0/8”. The internal network relay device 300b then searches the ARP table 355b and the source address table 356b of the self-device 300b for a destination MAC address and an output network interface corresponding to the destination IP address “40.1.1.4” of the route information. The internal network relay device 300b detects a destination MAC address “50a-200a” from the ARP table 355b, while detecting the network interface 31a of the internal network relay device 300a and the network interface 31c of the internal network relay device 300c as the corresponding network interfaces from the source address table 356b.

The address space information correlated to the route information in the IP address range “100.0.0.0/8” in the allocation route table 352b indicates the presence of route information having a longer prefix length in any other internal network relay device 300. The internal network relay device 300b accordingly selects the internal network relay device 300c as the internal network relay device 300 which the data frame does not go through, and transfers the data frame with the attached internal transfer header 780 to the selected internal network relay device 300c.

A MAC address “33c” and a MAC address “34b” are respectively set as the destination MAC address and the source MAC address in the Ethernet header of the first header information 781 of the internal transfer header 780 attached by the internal network relay device 300b. An IP address “10.1.23.2” and an IP address “10.1.23.1” are respectively set as the destination IP address and the source IP address in the IP Header of the first header information 781.

An identifier representing a continuation request is stored in the second header information 782 of the internal transfer header 780 attached by the internal network relay device 300b. An identifier identifying an output network interface corresponding to the route information in the IP address range “100.0.0.0/8” and information representing a prefix length “8” of the route information are stored in the third header information 783. A bit map enabling the first bit and the second bit out of the three bits is stored in the fourth header information 784.

### Transfer Operation T140

When the network interface 33c receives the data frame, the internal network relay device 300c removes the internal transfer header 780 attached to the received data frame and checks the second header information 782 of the removed internal transfer header 780. The identifier representing the continuation request is stored in the second header information 782 of the internal transfer header 780. The internal network relay device 300c accordingly searches the allocation route table 352c of the self-device 300c for route information corresponding to the destination IP address “100.1.1.1” of the data frame.

The internal network relay device 300c detects route information in an IP address range “100.1.1.0/24” corresponding to the destination IP address “100.1.1.1” of the data frame from the allocation route table 352c of the self-device 300c. The internal network relay device 300c refers to the destination IP address “40.1.1.4” correlated to the route information in the IP address range “100.1.1.0/24”. The internal network relay device 300c then searches the ARP table 355c and the source address table 356c of the self-device 300c for a destination MAC address and an output network interface corresponding to the destination IP address “40.1.1.4” of the route information. The internal network relay device 300c detects the destination MAC address “50a-200a” from the ARP table 355c, while detecting the network interface 31a of the internal network relay device 300a and the network interface 31c of the internal network relay device 300c as the corresponding network interfaces from the source address table 356c.

The address space information correlated to the route information in the IP address range “100.1.1.0/24” in the allocation route table 352c indicates the absence of any route information having a longer prefix length in any of the other internal network relay devices 300. The internal network relay device 300c accordingly changes the destination MAC address of the Ethernet header 710 of the data frame to the destination IP address “40.1.1.4” correlated to the route information in the IP address range “100.1.1.0/24”. The internal network relay device 300c then transfers the data frame from the network interface 31c of the self-device 300c to the external network relay device 200a. The data frame sent from the terminal device 610b of the external network 20b is thus eventually transferred to the terminal device 610a of the external network 20a.

A2-5. Update of Route Information

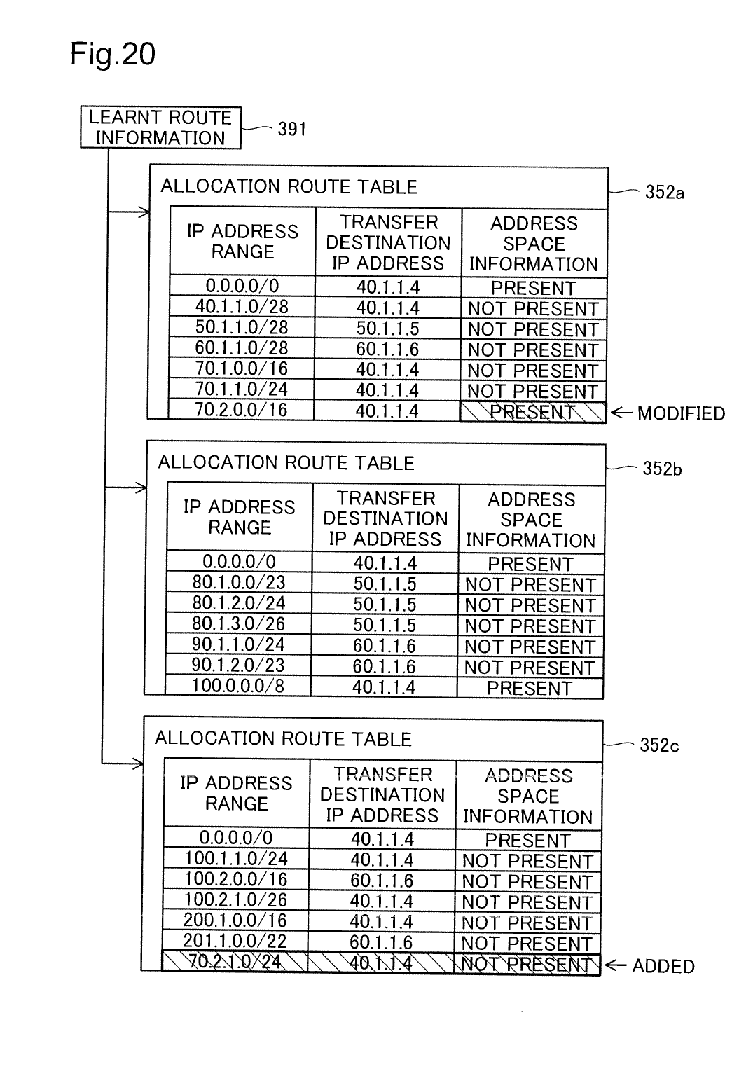

FIG. 20 is an explanatory diagram showing the updated allocation route tables 352. The allocation route tables 352 are updated from the state of FIG. 13 to the state of FIG. 20, in response to addition of new route information in an IP address range “70.2.1.0/24” to the external network 20a. The hatched portions in FIG. 20 indicate changes from the state of FIG. 13. In this embodiment, in order to substantially equalize the numbers of pieces of route information allocated to the respective allocation route tables 352, the newly added route information is allocated to the allocation route table 352c.

Due to the allocation of the new route information in the IP address range “70.2.1.0/24” to the allocation route table 352c, with regard to route information in an IP address range “70.2.0.0/16” included in the allocation route table 352a, there is the route information in the IP address range belonging to the common IP address space and having the longer prefix length in another allocation route table 352. The address space information correlated to the route information in the IP address range “70.2.0.0/16” is thus changed to the address space information representing “present”. With regard to the route information in the IP address range “70.2.1.0/24”, there is no route information in an IP address range belonging to the common IP address space and having a longer prefix length in any of the other allocation route tables 352. The address space information representing “not present” is thus correlated to the route information in the IP address range “70.2.1.0/24”.

A2-6. Restoration on the Occurrence of Failure

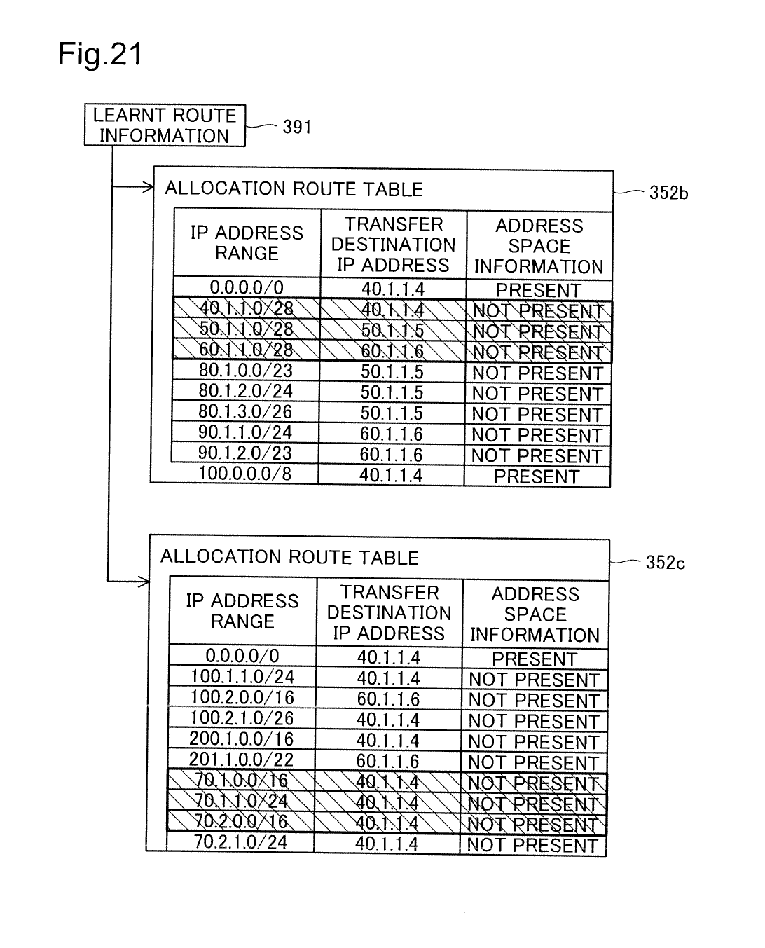

FIG. 21 is an explanatory diagram showing the allocation route tables 352 reallocated for the purpose of restoration on the occurrence of failure. The allocation route tables 352 are reallocated from the state of FIG. 20 as the action against failure occurring in the internal network relay device 300a. The hatched portions in FIG. 21 indicate changes from the state of FIG. 20. In this embodiment, on the occurrence of failure in the internal network relay device 300a, the internal network relay device 300b works as the protocol processing device, in place of the internal network relay device 300a.

In the illustrated example of FIG. 21, the pieces of route information allocated to the allocation route table 352a of the internal network relay device 300a are assigned to the allocation route tables 352b and 352c of the normal internal network relay devices 300b and 300c. Accompanied with such assignment, the address space information correlated to each piece of the reallocated route information is modified. Before assignment, the address space information representing “present” is correlated to the route information in the IP address range “70.2.0.0/16”. Reallocation of this route information in the IP address range “70.2.0.0/16” to the allocation route table 352c including the route information in the IP address range “70.2.1.0/24” causes the address space information representing “not present” to be correlated to this reallocated route information in the IP address range “70.2.0.0/16”.

A3. Advantages of First Embodiment

In the network relay system 30 of the first embodiment described above, each of the plurality of internal network relay devices 300 performs the routing process according to the longest match rule, based on the address space information correlated to the allocation route tables 352. This arrangement enables the routing process in the network relay system 30 to be effectively shared to the plurality of internal network relay devices 300 according to the longest match rule.

The address space information shows whether route information in an IP address space belonging to a common IP address space and having a longer prefix length is present in any other internal network relay device 300. Each of the plurality of internal network relay devices 300 determines the longest match between the route information registered in the self-device 300 and the route information registered in the other internal network relay devices 300, based on the address space information, and implements the routing process according to the longest match rule.

The attachment of the internal transfer header 780 to the data frame enables the data frame to be smoothly transferred between the plurality of internal network relay devices 300.

A4. Modification of First Embodiment

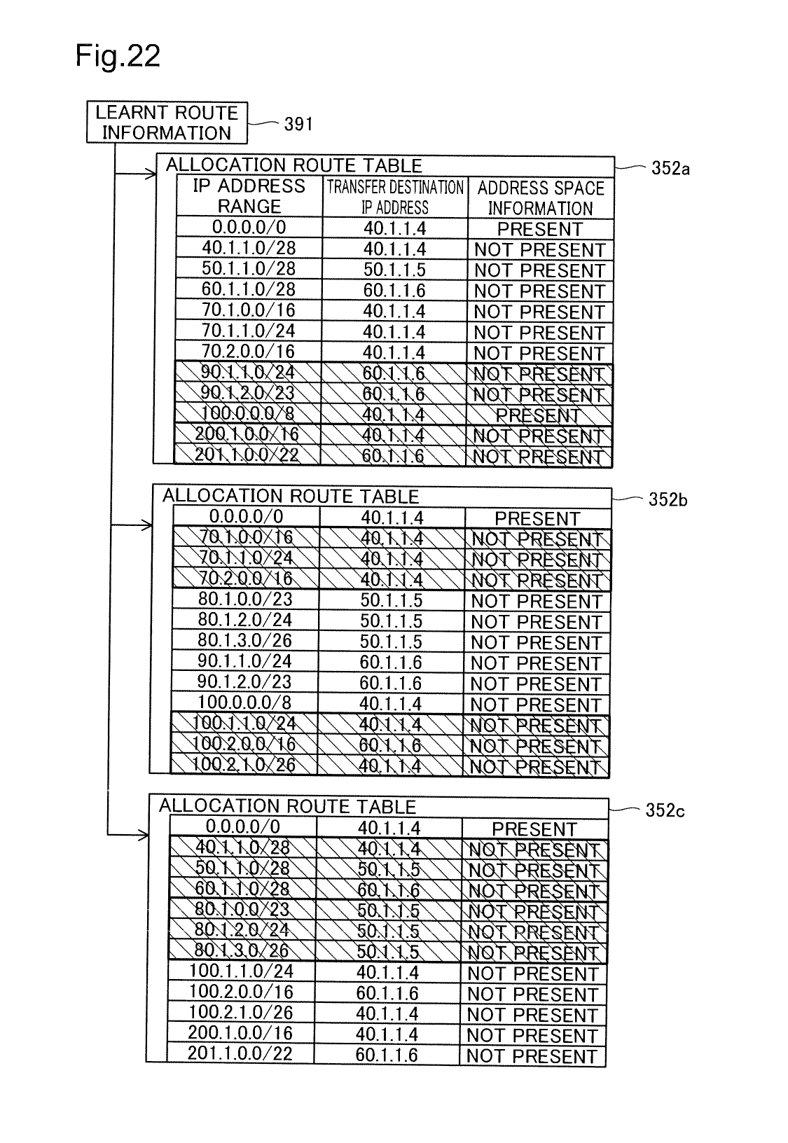

FIG. 22 is an explanatory diagram showing allocation route tables 352 in modified example 1 of the first embodiment. In modified example 1 of the first embodiment, identical pieces of route information are allocated in a duplicative manner to at least two allocation route tables 352. The hatched portions in FIG. 22 indicate duplicative allocations from the state of FIG. 13. On the occurrence of failure in one of the plurality of internal network relay devices 300, this arrangement of modified example 1 of the first embodiment enables the routing process to be continued, based on the route information registered in another normal internal network relay device 300.

In modified example 2 of the first embodiment, the address space information may not be correlated to each piece of the route information in the allocation route tables 352. The transfer process (step S300) of modified example 2 implements the respective processing steps on the assumption that the address space information representing “present” is allocated to all the pieces of route information and performs the route search operation in all the internal network relay devices 300. This arrangement of modified example 2 of the first embodiment simplifies the process of creating the plurality of allocation route tables 352.

### B. Second Embodiment

B1. Configuration of Computer Network

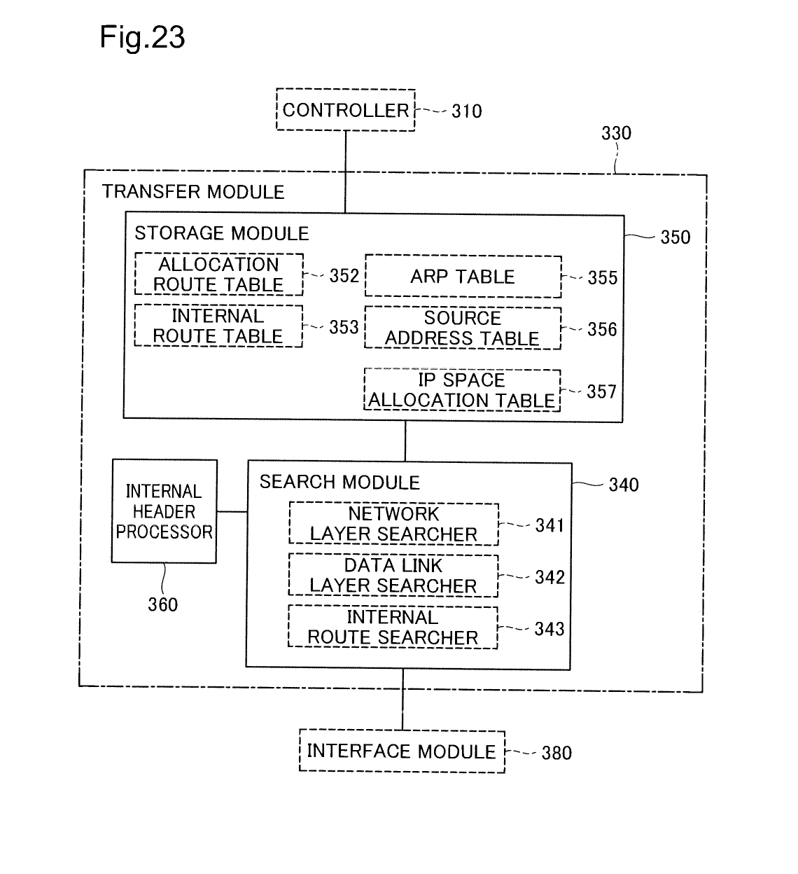

The configuration of a computer network 10 in a second embodiment of the invention is similar to the configuration in the first embodiment discussed above, except the structure of the internal network relay device 300. FIG. 23 is an explanatory diagram showing the detailed structure of the transfer module 330 included in the internal network relay device 300 of the second embodiment. The structure of the internal network relay device 300 of the second embodiment is similar to that of the first embodiment, except addition of an IP space allocation table 357 for storage of address space information in the storage module 350 of the transfer module 330. The details of the IP space allocation table 357 will be described later.

B2. Operations of Computer Network

The operations of the computer network 10 in the second embodiment are similar to those in the first embodiment, except some operations performed by the internal network relay device 300. The different operations by the internal network relay device 300 of the second embodiment from those of the first embodiment are a transfer preparation process and a transfer process as described below.

B2-1. Transfer Preparation Process

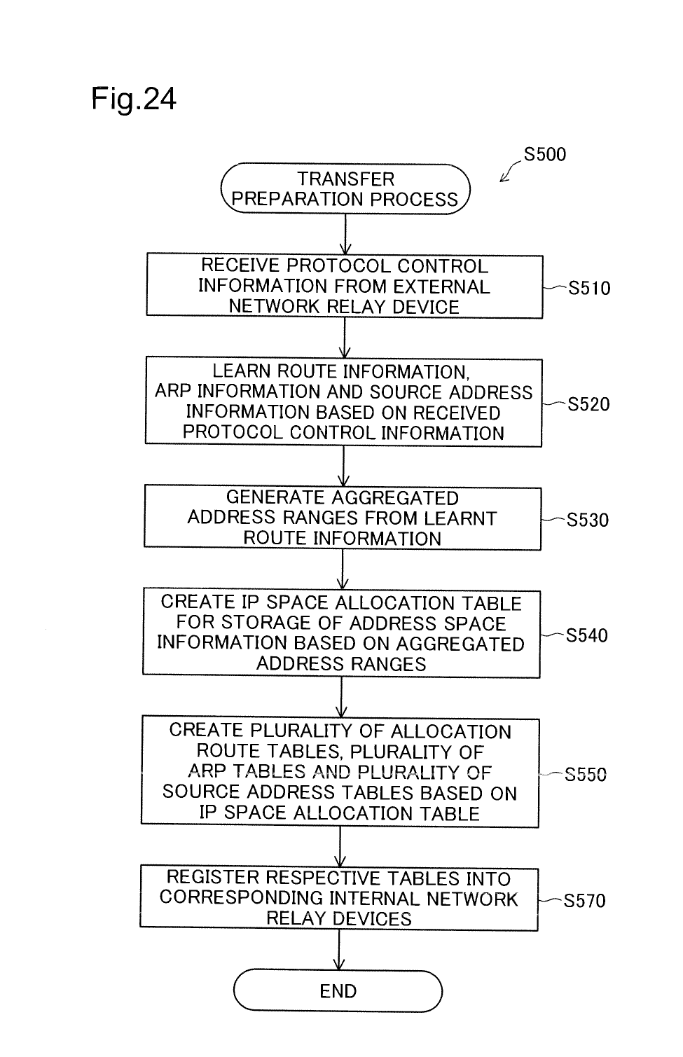

FIG. 24 is a flowchart showing a transfer preparation process (step S500) performed in the second embodiment. The transfer preparation process (step S500) provides each of the plurality of internal network relay devices 300 with a corresponding allocation route table 352, a corresponding ARP table 355, a corresponding source address table 356 and the IP space allocation table 357. In this embodiment, the transfer preparation process (step S500) is implemented through the operations of the CPU 311 of the controller 310 according to the control program 320. In this embodiment, in response to reception of protocol control information or control information regarding the communication protocol from the external network 20, the controller 310 of the internal network relay device 300 specified as the protocol processing device by the protocol processing device specification process (step S100) starts the transfer preparation process (step S500).

On the start of the transfer preparation process (step S500), in the same manner as the first embodiment, the controller 310 of the internal network relay device 300 receives the protocol control information from the external network relay device 200 of the external network 20 (step S510). After receiving the protocol control information (step S510), in the same manner as the first embodiment, the controller 310 serves as the information learner 321 to learn the route information, the ARP information and the source address information, based on the received protocol control information and relevant pieces of known information and generate the learnt route information 391, the learnt ARP information 392 and the learnt source address information 393 (step S520).

After generating the learnt route information 391, the learnt ARP information 392 and the learnt source address information 393 (step S520), the controller 310 serves as a first generator of the space information generator 323 to generate a plurality of aggregated address ranges from the learnt route information 391 (step S530). The aggregated address range is an IP address range with a shortened prefix length obtained by aggregating IP address ranges belonging to a common IP address space among the multiple pieces of route information included in the learnt route information 391. In this embodiment, the aggregated address ranges are generated for the multiple pieces of route information included in the learnt route information 391, except allocation object route information as the object to be allocated to the plurality of internal network relay devices 300, i.e., the route information in the IP address range “0.0.0.0/0” set as the common route information.

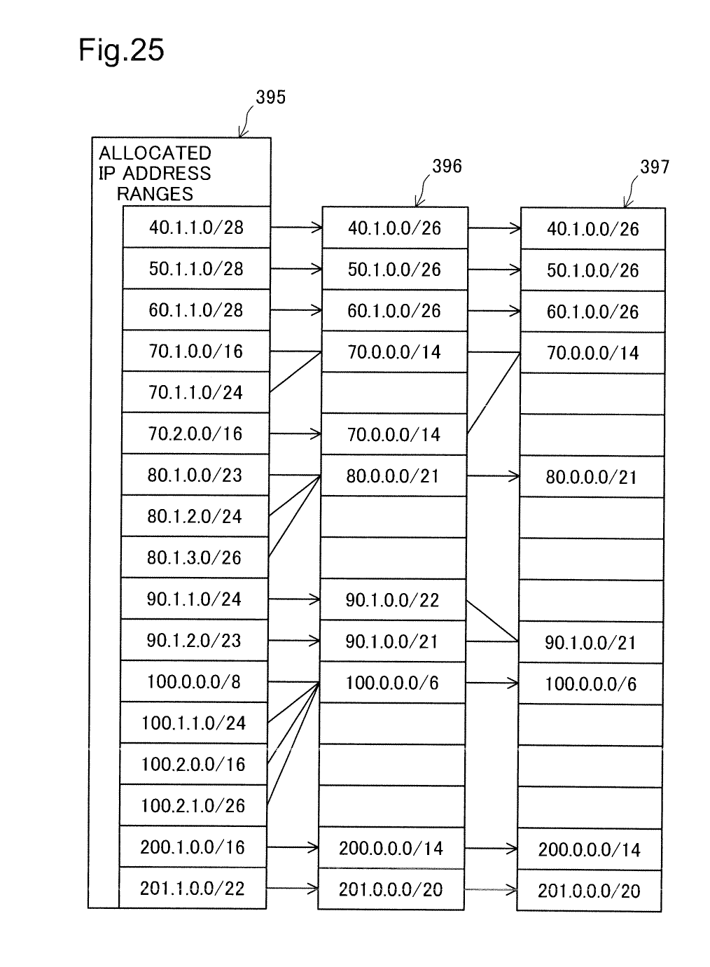

FIG. 25 is an explanatory diagram showing generation of aggregated address ranges 397. The left column of FIG. 25 shows allocated IP address ranges 395, the middle column shows reorganized address ranges 396, and the right column shows the aggregated address ranges 397. The allocated IP address ranges 395 are IP address ranges of allocation object route information as the objects to be allocated to the plurality of internal network relay devices 300. Each of the reorganized address ranges 396 is an IP address range with a shortened prefix length obtained by shortening a shortest prefix length of IP address ranges belonging to a common IP address space among the allocated IP address ranges 395. Each of the aggregated address ranges 397 is an IP address range obtained by aggregating IP address ranges belonging to a common IP address space among the reorganized address ranges 396.

In this embodiment, the reorganized address range 396 is obtained by shortening, by 2 bits, the shortest prefix length of the IP address ranges belonging to the common IP address space among the allocated IP address ranges 395. In other embodiments, the number of bits to be shortened may be 1 bit or may be 3 or more bits. In this embodiment, the prefix length shortened from the allocated IP address ranges 395 to the reorganized address ranges 396 should not be shortened to 0 bit but should be 1 bit at the shortest. For example, an IP address range “128.0.0.0/1” included in the allocated IP address ranges 395 should be incorporated in the aggregated address ranges 397 without shortening the prefix length of this IP address range.

Referring back to the flowchart of FIG. 24, after creating the plurality of aggregated address ranges 397 (step S530), the controller 310 serves as a second generator of the space information generator 323 to create the IP space allocation table 357 for storage of address space information, based on the aggregated address spaces 397 (step S540). The IP space allocation table 357 stores information on allocating the plurality of aggregated address ranges 397 to the plurality of internal network relay devices 300.

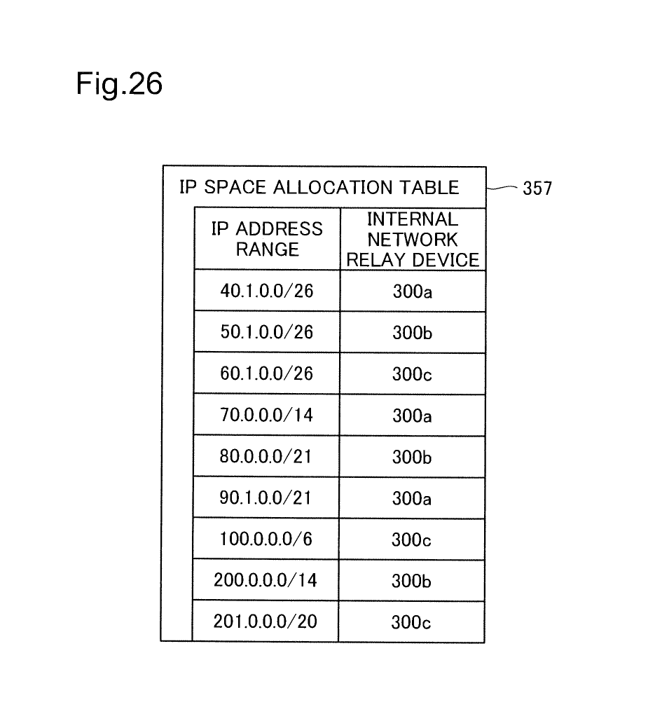

FIG. 26 is an explanatory diagram showing the IP space allocation table 357. The IP space allocation table 357 stores the IP address ranges included in the plurality of aggregated address ranges 397 and the internal network relay devices 300, which the respective IP address ranges are allocated to. In this embodiment, the plurality of aggregated address ranges 397 in the IP space allocation table 357 are allocated to the plurality of internal network relay devices 300 in such a manner as to substantially equalize the numbers of the allocated IP address ranges 395 corresponding to the aggregated address ranges 397 allocated to the respective internal network relay devices 300.

Referring back to the flowchart of FIG. 24, after creating the IP space allocation table 357 (step S540), the controller 310 serves as the information allocator 322 to create a plurality of allocation route tables 352, a plurality of ARP tables 355 and a plurality of source address tables 356 corresponding to the respective internal network relay devices 300, based on the IP space allocation table 357 (step S550). The controller 310 then serves as the information registrator 324 to register the plurality of allocation route tables 352, the plurality of ARP tables 355, the plurality of source address tables 356 and the IP space allocation table 357 correspondingly into the plurality of internal network relay devices 300 (step S570). The identical IP space allocation table 357 is registered in each of the plurality of internal network relay devices 300. The tables other than the IP space allocation table 357 are registered correspondingly in the respective internal network relay devices 300.

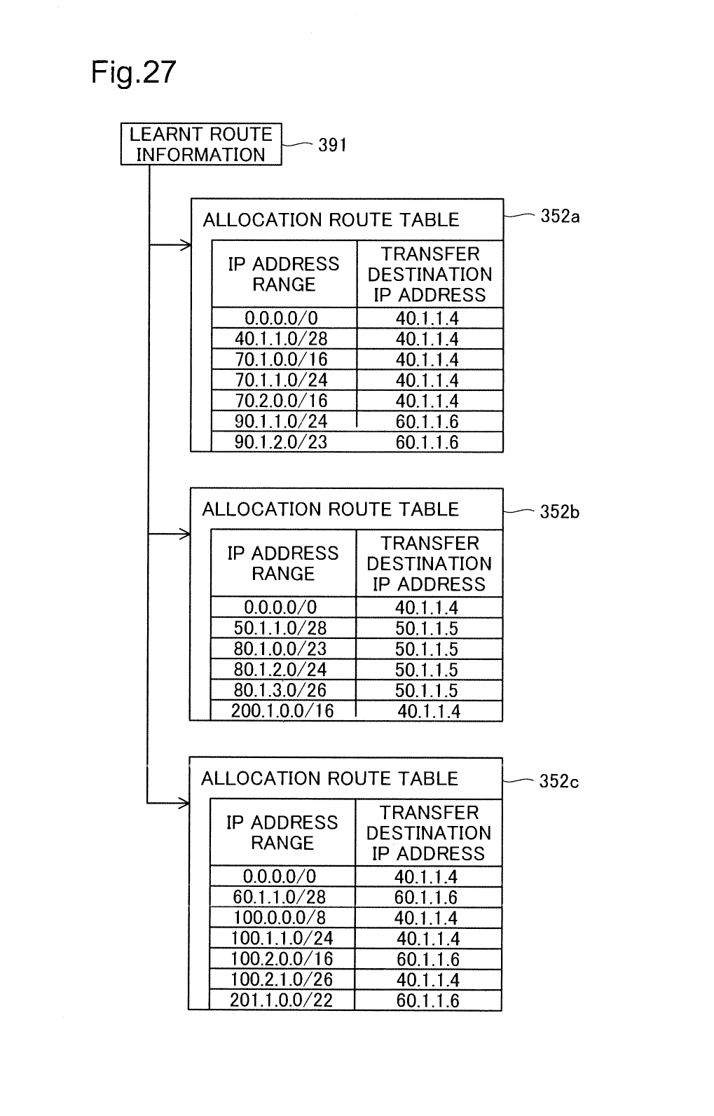

FIG. 27 is an explanatory diagram showing the allocation route tables 352 in the second embodiment. Multiple pieces of route information in the learnt route information 391 are allocated in units of the route information to the plurality of allocation route tables 352, based on the IP space allocation table 357. In this embodiment, the multiple pieces of route information in the learnt route information 391 are allocated to the plurality of allocation route tables 352, such that substantially equal numbers of pieces of route information are allocated to the respective allocation route tables 352. In this embodiment, the route information of the IP address range “0.0.0.0/0” is set as the common route information commonly allocated to the plurality of allocation route tables 352.

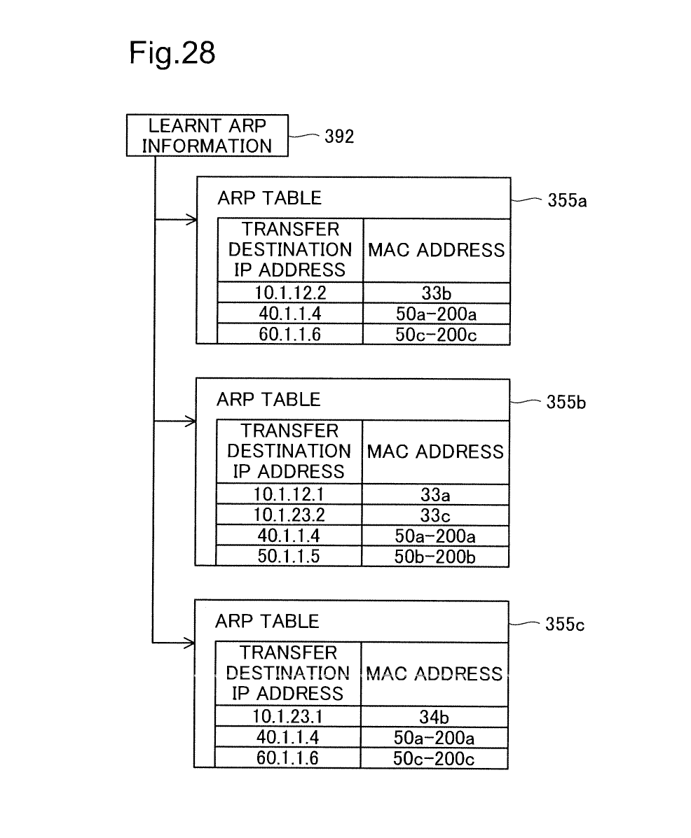

FIG. 28 is an explanatory diagram showing the ARP tables 355 in the second embodiment. Multiple pieces of ARP information in the learnt ARP information 392 are allocated to the plurality of ARP tables 355 according to the corresponding allocation route tables 352.

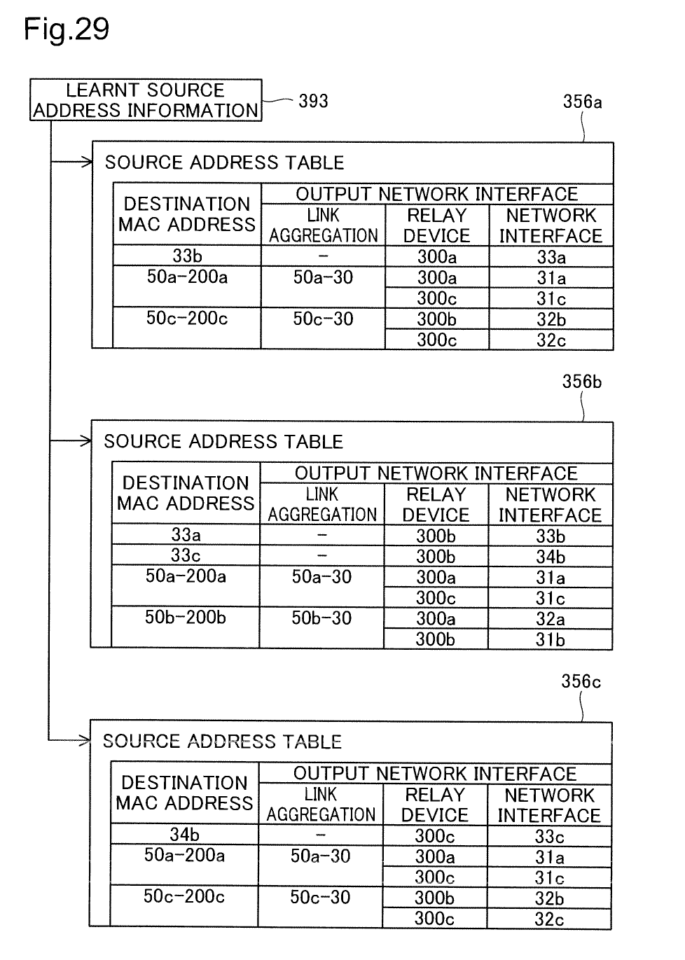

FIG. 29 is an explanatory diagram showing the source address tables 356 in the second embodiment. Multiple pieces of source address information in the learnt source address information 393 are allocated to the plurality of source address tables 356 according to the corresponding ARP tables 355.

B2-2. Transfer Process

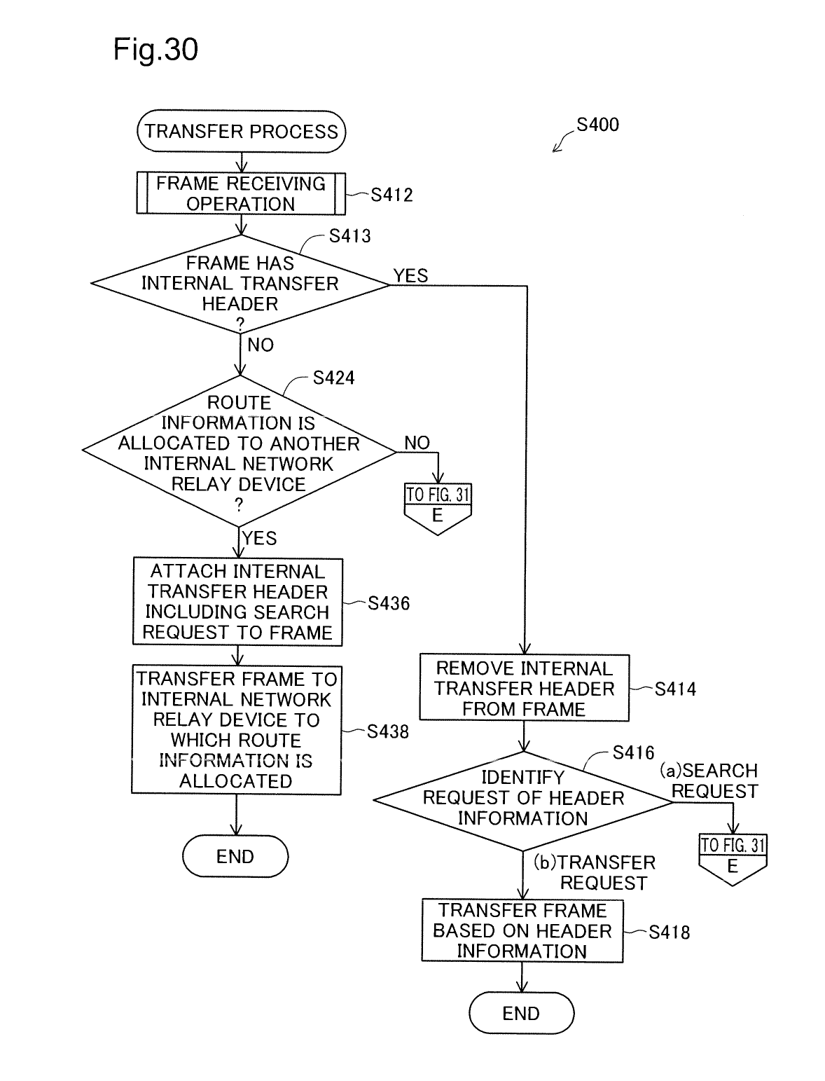

FIGS. 30 and 31 are flowcharts showing a transfer process (step S400) performed by the transfer module 330 of the internal network relay device 300 in the second embodiment. The transfer process (step S400) relays the data frame. In this embodiment, the transfer process (step S400) is implemented through the operations of the search module 340 and the internal header processor 360 of the transfer module 330 based on the respective electric circuit structures. In another embodiment, at least part of the functions of the transfer process (step S400) may be implemented through the operations of the CPU according to a program. In this embodiment, the transfer module 330 starts the transfer process (step S400), when the interface module 380 receives a data frame.

Referring to the flowchart of FIG. 30, on the start of the transfer process (step S400), the transfer module 330 of the internal network relay device 300 performs a frame receiving operation (step S412). The frame receiving operation (step S412) performed by the transfer module 330 receives the data frame from the interface module 380 and analyzes the header information attached to the received data frame.

After performing the frame receiving operation (step S412), the transfer module 330 determines whether the received data frame has the internal transfer header 780 (step S413). In this embodiment, when the internal network relay device 300 receives a data frame from the external network relay device 200, the received data frame does not have the internal transfer header 780. When the internal network relay device 300 receives a data frame from another internal network relay device 300, on the other hand, the received data frame has the internal transfer header 780.

When the received data frame does not have the internal transfer header 780, i.e., when the data frame is received from the external network relay device 200 (step S413: No), the transfer module 330 determines whether the route information is allocated to any other internal network relay device 300, based on the IP space allocation table 357 (step S424). More specifically, the transfer module 330 refers to the destination IP address of the IP header 720 attached to the received data frame and searches the IP space allocation table 357 registered in the storage module 350 of the self-device 300 for the internal network relay device 300 allocated to the IP address range corresponding to the destination IP address.

When the route information is not allocated to any other internal network relay device 300 (step S424: No), the processing flow goes to FIG. 31. The transfer module 330 then serves as the route searcher to perform a route search operation (step S442). The route search operation (step S442) performed by the transfer module 330 searches the allocation route table 352 stored in the storage module 350 of the self-device 300 for route information corresponding to the received data frame. More specifically, the transfer module 330 refers to the destination IP address of the IP header 720 attached to the received data frame and searches the allocation route table 352 registered in the storage module 350 of the self-device 300 for the route information in the IP address range corresponding to the destination IP address.

When the corresponding route information is detected as the result of the route search operation (step S442) (step S444: Yes), the transfer module 330 searches for an output network interface corresponding to the detected route information of the self-device 300 (step S446). More specifically, the transfer module 330 searches the ARP table 355 of the self-device 300 for a destination MAC address corresponding to the transfer destination IP address (next hop) of the mute information detected from the allocation route table 352 of the self-device 300. The transfer module 330 then searches the source address table 356 of the self-device 300 for an output network interface corresponding to the destination MAC address detected from the ARP table 355 of the self-device 300.

After searching for the corresponding output network interface (step S446), the transfer module 330 changes the destination MAC address of the Ethernet header 710 attached to the data frame to the destination MAC address of the ARP information corresponding to the route information of the self-device 300 detected by the route search operation (step S442) (step S452). The transfer module 330 then determines whether an output network interface corresponding to the route information of the self-device 300 detected by the route search operation (step S442) is present in the self-device 300 (step S454).

When the corresponding output network interface is present in the self-device 30 (step S454: Yes), the transfer module 330 changes the source MAC address of the Ethernet header 710 attached to the data frame to the MAC address of the corresponding output network interface and transfers the data frame from the corresponding output network interface of the self-device 300 to the external network relay device 200 (step S458).

When the corresponding output network interface is not present in the self-device 30 (step S454: No), on the other hand, the transfer module 330 serves as the instruction adder to add the internal transfer header 780 including a transfer request to the data frame (step S466). More specifically, the transfer module 330 stores an identifier identifying another internal network relay device 300 having the corresponding output network interface, as the first header information 781 of the internal transfer header 780, while storing an identifier representing a transfer request that gives an instruction to transfer the data frame to the another internal network relay device 300 having the corresponding output network interface, as the second header information 782 of the internal transfer header 780. The transfer module 330 further stores an identifier identifying the corresponding output network interface, as the third header information 783, in addition to the first header information 781 and the second header information 782 of the internal transfer header 780. In the second embodiment, the fourth header information 784 is not used.

After attaching the internal transfer header 780 to the data frame (step S466), the transfer module 330 transfers the data frame with the attached internal transfer header 780 to the another internal network relay device 300 having the corresponding output network interface, based on the contents of the internal route table 353 stored in the storage module 350 of the self-device 300 (step S468).

When no corresponding route information is detected as the result of the route search operation (step S442) (step S444: No), the transfer module 330 performs a non-routing operation (step S448). In this embodiment the non-routing operation (step S448) performed by the transfer module 330 notifies the sender of the data frame of failed relay of the data frame.

Referring back to the flowchart of FIG. 30, when the route information is allocated to another internal network relay device 300 (step S424: Yes), the transfer module 330 serves as the instruction adder to add the internal transfer header 780 including a search request to the data frame (step S436). More specifically, the transfer module 330 stores an identifier identifying the another internal network relay device 300, to which the route information is allocated, as the first header information 781 of the internal transfer header 780, while storing an identifier representing a search request that gives an instruction for route search to the another internal network relay device 300, to which the route information is allocated, as the second header information 782 of the internal transfer header 780. The transfer module 330 further stores an identifier representing absence of any candidate for route information, as the third header information 783, in addition to the first header information 781 and the second header information 782 of the internal transfer header 780. As explained above, the fourth header information 784 is not used in the second embodiment.

After attaching the internal transfer header 780 to the data frame (step S436), the transfer module 330 transfers the data frame with the attached internal transfer header 780 to the another internal network relay device 300, to which the route information is allocated, based on the contents of the internal route table 353 stored in the storage module 350 of the self-device 300 (step S438).

When the received data frame has the internal transfer header 780, i.e., when the data frame is received from another internal network relay device 300 (step S413: Yes), the transfer module 330 removes the internal transfer header 780 from the data frame received by the frame receiving operation (step S412) (step S414). The transfer module 330 then analyzes the identifier stored as the second header information 782 of the internal transfer header 780 removed from the received data frame (step S416).

When the analyzed identifier of the second header information 782 of the internal transfer header 780 represents a search request (step S416: “a”), the transfer module 330 performs the route search operation (step 442) and the subsequent processing discussed above with reference to the flowchart of FIG. 31, with regard to the data frame after removal of the internal transfer header 780.

When the analyzed identifier of the second header information 782 of the internal transfer header 780 represents a transfer request (step S416: “b”), the transfer module 330 transfers the received data frame from the output network interface of the self-device 300 to the external network relay device 200, based on the third header information 783 of the internal transfer header 780 removed from the received data frame (step S418).

B2-3. Example of Data Frame Transfer

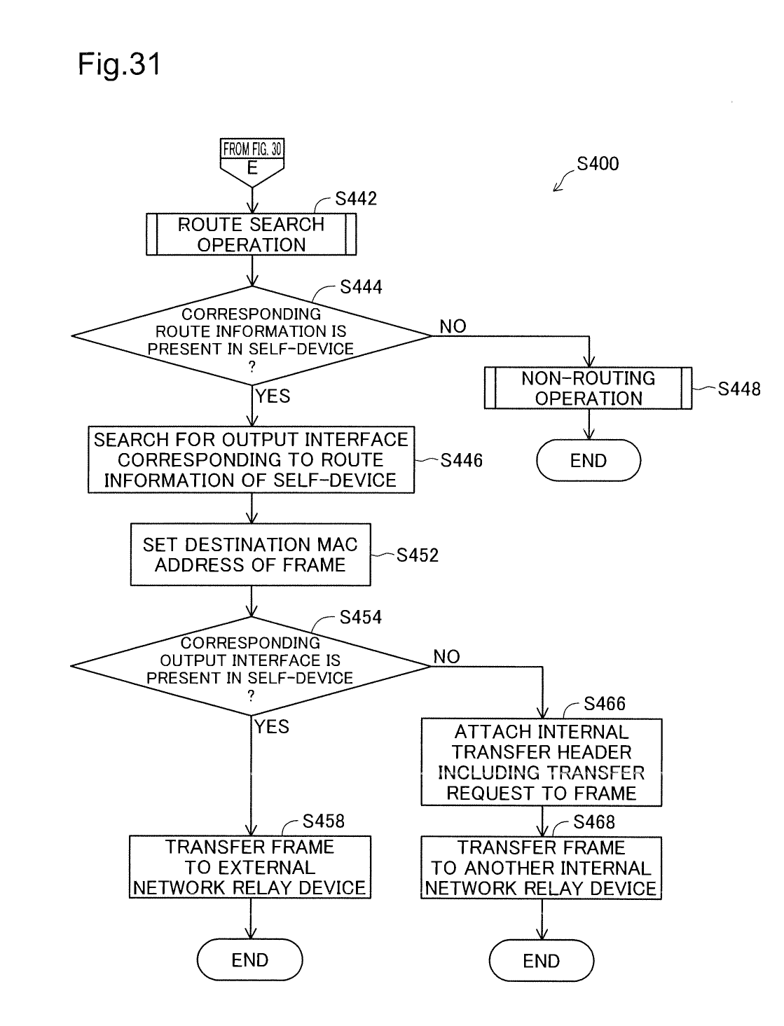

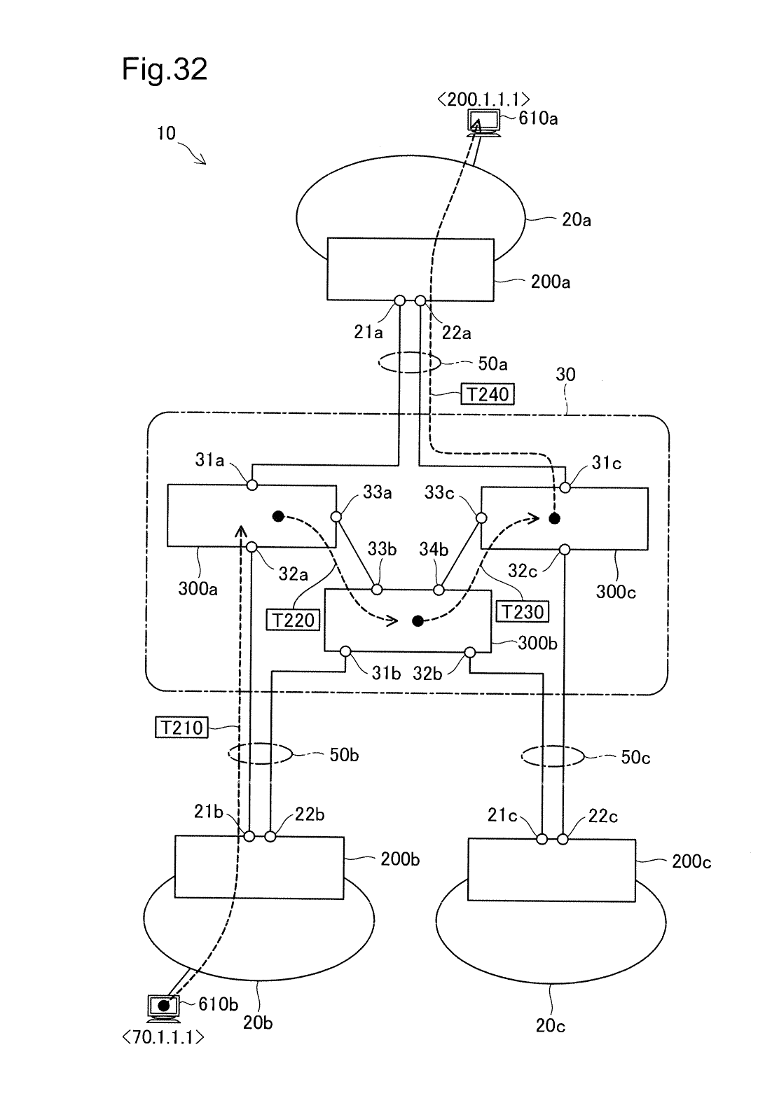

FIG. 32 is an explanatory diagram showing one example of data frame transfer in the second embodiment. In the illustrated example of FIG. 32, a data frame is transferred from the terminal device 610b connecting with the external network 20b to the terminal device 610a connecting with the external network 20a. The terminal device 610b has a set IP address “70.1.1.1”, and the terminal device 610a has a set IP address “200.1.1.1”.

### Transfer Operation T210

The IP address “200.1.1.1” of the terminal device 610a and the IP address “70.1.1.1” of the terminal device 610b are respectively set as the destination IP address and the source IP address in the IP header 720 of the data frame sent from the terminal device 610b. In the illustrated example of FIG. 32, the data frame sent from the terminal device 610b goes through the link aggregation 50b and is transferred to the internal network relay device 300a. A MAC address “50b-300a” and a MAC address “50b-200b” are respectively set as the destination MAC address and the source MAC address in the Ethernet header 710 of the data frame going through the network interface 21b of the external network relay device 200b.

### Transfer Operation T220

When the network interface 32a receives the data frame, the internal network relay device 300a identifies which of the plurality of internal network relay devices 300 the route information corresponding to the destination IP address “200.1.1.1” of the data frame is allocated to, based on the IP space allocation table 357 of the self-device 300a. In the IP space allocation table 357 of FIG. 26, the destination IP address “200.1.1.1” belongs to an IP address range “200.0.0.0/14”, and the route information corresponding to the destination IP address “200.1.1.1” is allocated to the internal network relay device 300b. The internal network relay device 300a accordingly transfers the data frame with the attached internal transfer header 780 to the internal network relay device 300b.

The first header information 781 of the internal transfer header 780 attached by the internal network relay device 300a includes an Ethernet header and an IP header. A MAC address “33b” and a MAC address “33a” are respectively set as the destination MAC address and the source MAC address in the Ethernet header of the first header information 781. An IP address “10.1.12.2” and an IP address “10.1.12.1” are respectively set as the destination IP address and the source IP address in the IP Header of the first header information 781. An identifier representing a search request and an identifier representing absence of any candidate for route information are respectively stored in the second header information 782 and in the third header information 783 of the internal transfer header 780 attached by the internal network relay device 300a.

### Transfer Operation T230

When the network interface 33b receives the data frame, the internal network relay device 300b removes the internal transfer header 780 attached to the received data frame and checks the second header information 782 of the removed internal transfer header 780. The identifier representing the search request is stored in the second header information 782 of the internal transfer header 780. The internal network relay device 300b accordingly searches the allocation route table 352b of the self-device 300b for route information corresponding to the destination IP address “200.1.1.1” of the received data frame.

The internal network relay device 300b detects route information in an IP address range “200.1.0.0/16” corresponding to the destination IP address “200.1.1.1” of the data frame from the allocation route table 352b of the self-device 300b. The internal network relay device 300b refers to a destination IP address “40.1.1.4” correlated to the detected route information in the IP address range “200.1.0.0/16”. The internal network relay device 300b then searches the ARP table 355b and the source address table 356b of the self-device 300b for a destination MAC address and an output network interface corresponding to the destination IP address “40.1.1.4” of the route information. The internal network relay device 300b detects a destination MAC address “50a-200a” from the ARP table 355b, while detecting the network interface 31a of the internal network relay device 300a and the network interface 31c of the internal network relay device 300c as the corresponding network interfaces from the source address table 356b.

The internal network relay device 300b changes the destination MAC address of the Ethernet header 710 attached to the data frame to a MAC address “22b” corresponding to the destination IP address “40.1.1.4” correlated to the route information in the IP address range “200.1.0.0/16”. In this embodiment, the internal network relay device 300b then transfers the data frame with the attached internal transfer header 780 to the internal network relay device 300c of the detected two internal network relay devices 300a and 300c. In another embodiment, the data frame may be transferred to the internal network relay device 300a.

A MAC address “33c” and a MAC address “34b” are respectively set as the destination MAC address and the source MAC address in the Ethernet header of the first header information 781 of the internal transfer header 780 attached by the internal network relay device 300b. An IP address “10.1.23.2” and an IP address “10.1.23.1” are respectively set as the destination IP address and the source IP address in the IP Header of the first header information 781. An identifier representing a transfer request is stored in the second header information 782 of the internal transfer header 780 attached by the internal network relay device 300b. An identifier identifying the network interface 31c of the internal network relay device 300c as the corresponding output network interface is stored in the third header information 783.

### Transfer Operation T240

When the network interface 33c receives the data frame, the internal network relay device 300c removes the internal transfer header 780 attached to the received data frame and checks the second header information 782 of the removed internal transfer header 780. The identifier representing the transfer request is stored in the second header information 782 of the internal transfer header 780. The internal network relay device 300c accordingly transfers the data frame from the network interface 31c as the output network interface identified by the third header information 783 of the removed internal transfer header 780 to the external network relay device 200a. The data frame sent from the terminal device 610b of the external network 20b is thus eventually transferred to the terminal device 610a of the external network 20a.

B2-4. Update of Route Information

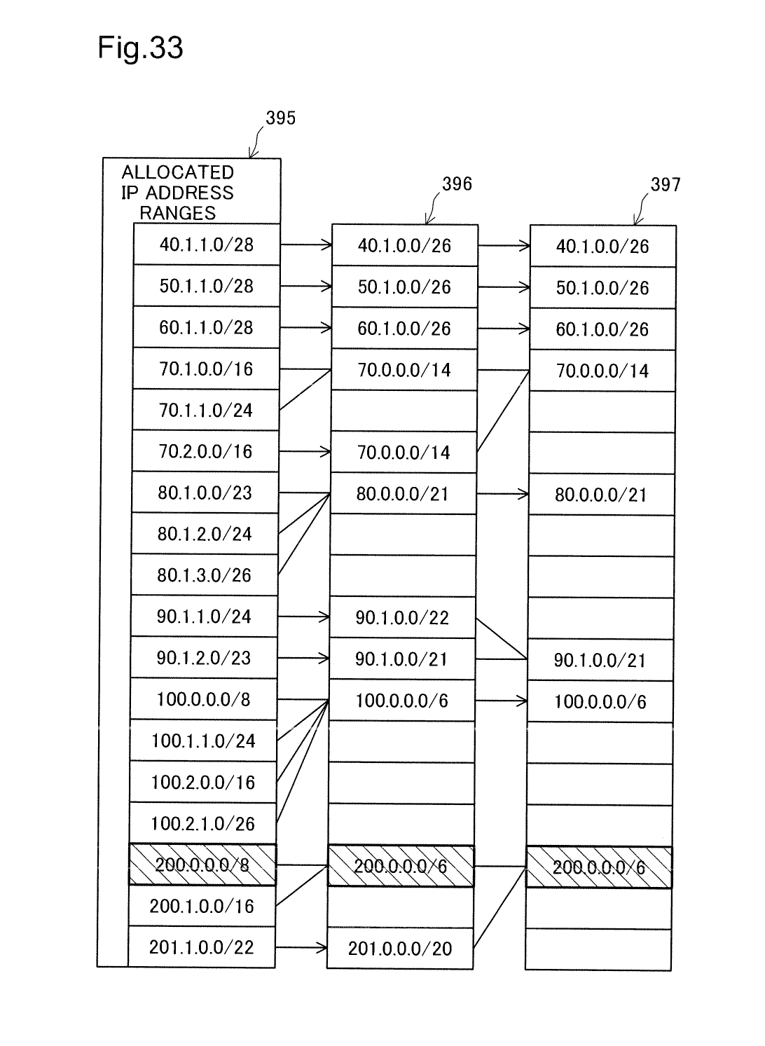

FIG. 33 is an explanatory diagram showing the updated aggregated address ranges 397. In the same manner as FIG. 25, the first column, the second column and the third column of FIG. 33 respectively show the allocated IP address ranges 395, the reorganized address ranges 396 and the aggregated address ranges 397. In the illustrated example of FIG. 33, an IP address range “200.0.0.0/8” is added to the allocated IP address ranges 395 in the state of FIG. 25. The hatched portions in FIG. 33 indicate changes from the state of FIG. 25.

In the illustrated example of FIG. 25 prior to the update, IP address ranges “200.1.0.0/16” and “201.1.0.0/22” in the allocated IP address ranges 395 are aggregated to IP address ranges “200.0.0.0/14” and “201.0.0.0/20” in the aggregated address ranges 397. In the illustrated example of FIG. 33 after addition of the IP address range “200.0.0.0/8” to the allocated IP address ranges 395, the IP address ranges “200.1.0.0/16”, “201.1.0.0/22” and the newly added IP address range “200.0.0.0/8” in the allocated IP address ranges 395 are aggregated to an IP address range “200.0.0.0/6” in the aggregated address ranges 397.

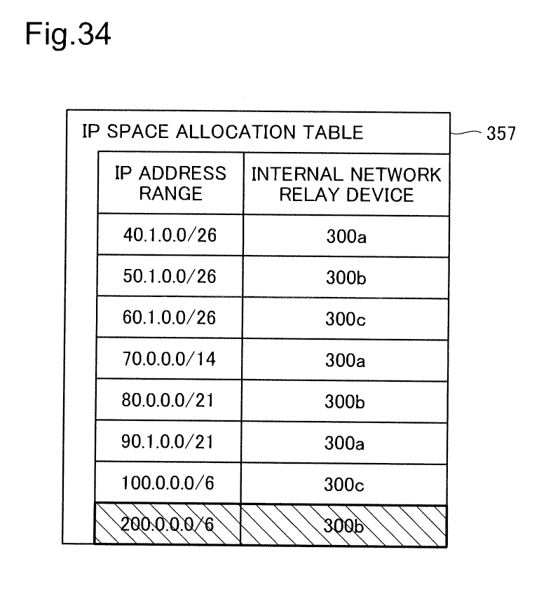

FIG. 34 is an explanatory diagram showing the updated IP space allocation table 357. In the illustrated example of FIG. 34, the newly aggregated IP address range “200.0.0.0/6” is allocated to the internal network relay device 300b. The hatched portions in FIG. 34 indicate changes from the state of FIG. 26. In this embodiment, the plurality of aggregated address ranges 397 in the IP space allocation table 357 are reallocated in such a manner as to substantially equalize the numbers of the allocated IP address ranges 395 corresponding to the aggregated address ranges 397 allocated to the plurality of internal network relay devices 300.

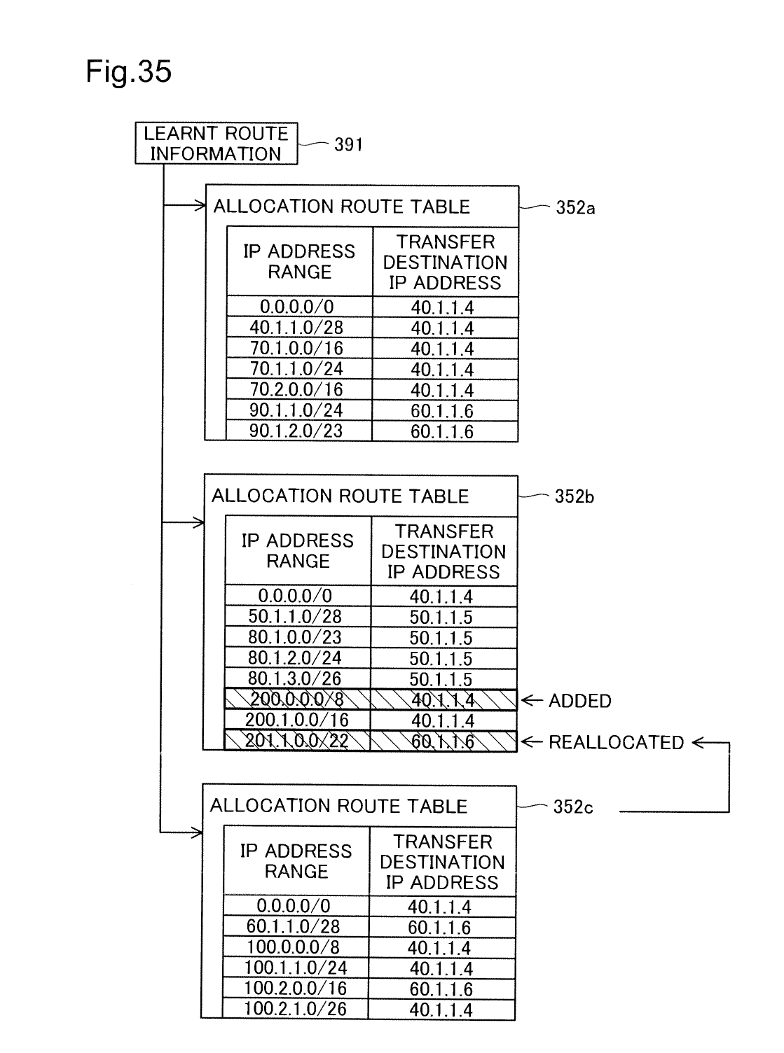

FIG. 35 is an explanatory diagram showing the updated allocation route tables 352. In the illustrated example of FIG. 35, the new IP address range “200.0.0.0/8” is added to the allocation route table 352b, based on the newly aggregated IP address range “20.0.0.0/6” in the IP space allocation table 357 of FIG. 34. The route information in the IP address range “201.1.0.0/22” originally allocated to the allocation route table 352c prior to the update is reallocated to the allocation route table 352b. The hatched portions in FIG. 35 indicate changes from the state of FIG. 27. The ARP tables 355 and the source address tables 356 are also updated according to the updated allocation route tables 352.

B2-5. Restoration on the Occurrence of Failure

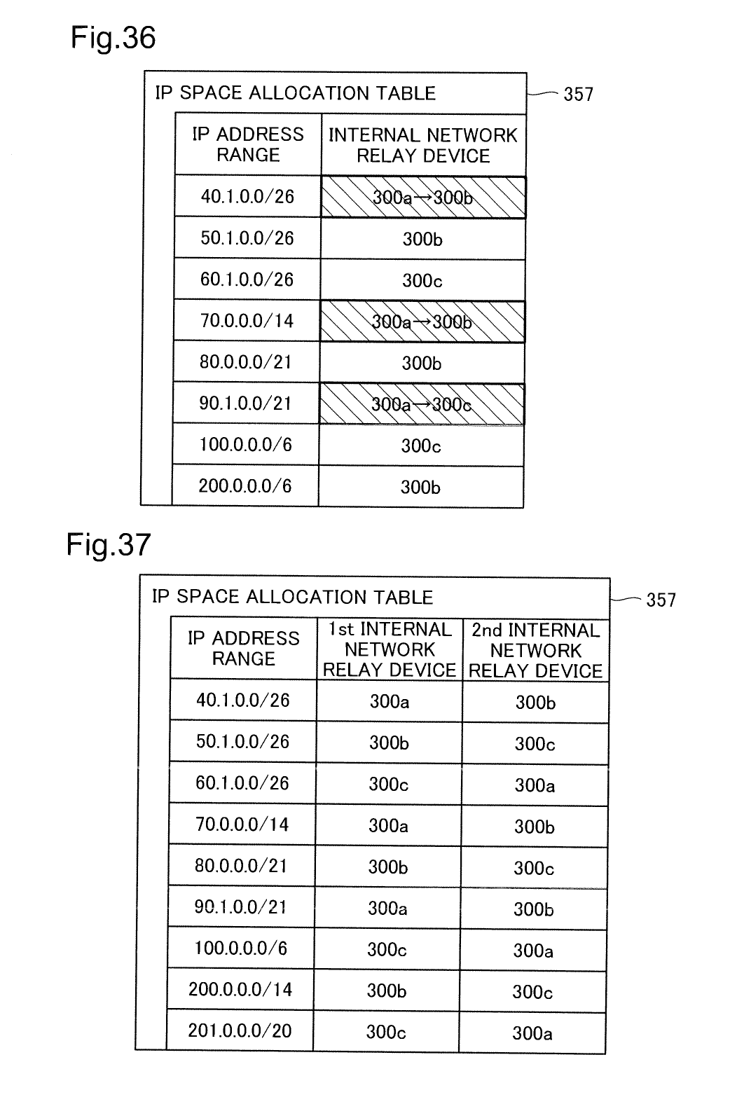

FIG. 36 is an explanatory diagram showing the IP space allocation table 357 reallocated for the purpose of restoration on the occurrence of failure. In the IP space allocation table 357 of FIG. 36, as the action against failure occurring in the internal network relay device 300a, the IP address ranges allocated to the internal network relay device 300a in the state of FIG. 34 are reallocated to the other internal network relay devices 300b and 300c. The hatched portions in FIG. 36 indicate changes from the state of FIG. 34. In this embodiment, the plurality of aggregated address ranges 397 in the IP space allocation table 357 are reallocated in such a manner as to substantially equalize the numbers of the allocated IP address ranges 395 corresponding to the aggregated address ranges 397 allocated to the plurality of internal network relay devices 300. The allocation route tables 352, the ARP tables 355 and the source address tables 356 are updated according to the reallocated IP space allocation table 357.

B3. Advantages of Second Embodiment

In the network relay system 30 of the second embodiment described above, each of the plurality of internal network relay devices 300 performs the routing process according to the longest match rule, based on the address space information registered in the form of the IP space allocation table 357 in the plurality of internal network relay devices 300. This arrangement enables the routing process in the network relay system 30 to be effectively shared to the plurality of internal network relay devices 300 according to the longest match rule.

The IP space allocation table 357 for storage of address space information allocates the aggregated address ranges 397 to the respective internal network relay devices 300. The plurality of allocation route tables 352 are created, based on the IP space allocation table 357. Each of the plurality of internal network relay devices 300 can thus implement the routing process without determining the longest match with the route information registered in the other internal network relay devices 300.

The attachment of the internal transfer header 780 to the data frame enables the data frame to be smoothly transferred between the plurality of internal network relay devices 300.

B4. Modification of Second Embodiment

FIG. 37 is an explanatory diagram showing an IP space allocation table 357 in a modified example of the second embodiment. In the IP space allocation table 357 of the modified example of the second embodiment, each of aggregated address ranges 397 is allocated to at least two internal network relay devices 300. Identical pieces of route information are allocated in a duplicative manner to at least two allocation route tables 352 among a plurality of allocation route tables 352 created according to the IP space allocation table 357. In this modified example of the second embodiment, when an identical piece of route information is present in both the self-device 300 and at least one other internal network relay device 300, the transfer process (step S400) is performed on the assumption of the presence of the route information in the self-device 300. When an identical piece of route information is present in at least two other internal network relay devices 300 other than the self-device 300, the transfer process (step S400) is performed on the assumption of the presence of the route information in one of the at least two other internal network relay devices 300 selected by some criterion, for example, the priority, the processing frequency, or the status of failure. On the occurrence of failure in one of the plurality of internal network relay devices 300, this modified example of the second embodiment enables the routing process to be continued, based on the route information registered in another normal internal network relay device 300.

### C. Third Embodiment

The configuration of a computer network 10 in a third embodiment of the invention is similar to that in the second embodiment discussed above, except the structures of the external network relay device 200 and the internal network relay device 300.

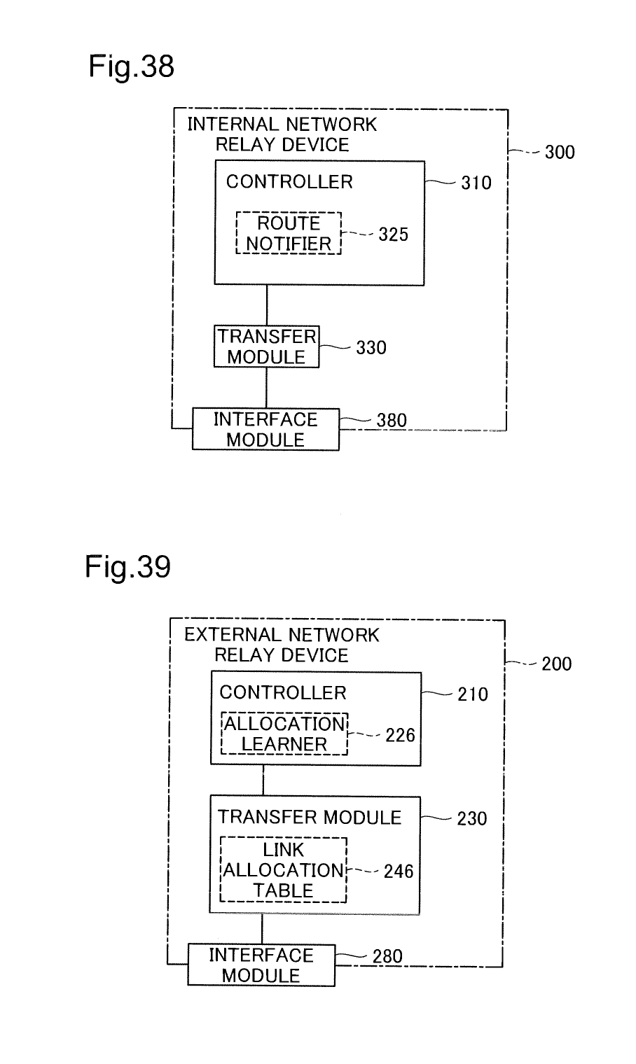

FIG. 38 is an explanatory diagram showing the structure of the internal network relay device 300 in the third embodiment. The structure of the internal network relay device 300 of the third embodiment is similar to that of the second embodiment, except addition of a route notifier 325. The route notifier 325 is implemented through the operations of the CPU 322 of the controller 310 according to the control program 320.

The route notifier 325 of the internal network relay device 300 is configured to notify the external network 20 connected with the self-device 300 by the ling aggregation among the plurality of external networks 20 of the IP address ranges allocated to the allocation route table 352 stored in the self-device 300. In this embodiment, in response to a request from the external network relay device 200 of the external network 20, the route notifier 325 notifies the external network relay device 200 of the IP address ranges allocated to the allocation route table 352 stored in the self-device 300. The route notifier 325 also notifies the external network relay device 200 of the aggregated address ranges 397 corresponding to the IP address ranges allocated to the allocation route tables 352 stored in the self-device 300.

FIG. 39 is an explanatory diagram showing the structure of the external network relay device 200 in the third embodiment. The external network relay device 200 of the third embodiment includes a controller 210, a transfer module 230 and an interface module 280. The controller 210 of the external network relay device 200 controls the operations of the transfer module 230 and the interface module 280. The transfer module 230 of the external network relay device 200 performs a process of transferring a data frame received by the interface module 280 to another network relay device. The interface module 280 of the external network relay device 200 includes a plurality of network interfaces 21 and 22, for example, Ethernet-based twist pair cables and optical fibers in this embodiment.

The controller 210 of the external network relay device 200 has an allocation learner 226. In this embodiment, the allocation learner 226 is implemented through the operations of a CPU of the controller 210 according to a program. The allocation learner 226 learns an IP address range as the allocation range of a destination IP address of a data frame, which is to be routed by each of connection destinations connected with the plurality of network interfaces 21 and 22 forming a link aggregation 50, from each connection destination, in correlation to the network interface 21 or 22 corresponding to the each connection destination. The allocation learner 226 creates a link allocation table 246 storing learnt IP address ranges and registers the created link allocation table 246 in the transfer module 230.

When the data frame to be sent via the link aggregation 50 has the destination IP address belonging to a certain IP address range included in the link allocation table 246, the transfer module 230 of the external network relay device 200 transfers the data frame from the network interface correlated to the certain IP address range. In this embodiment, when the link allocation table 246 does not include an IP address range, which the destination IP address of the data frame belongs to, the transfer module 230 transfers the data frame based on a preset criterion, for example, the priority, the frequency in use, or the status of failure.

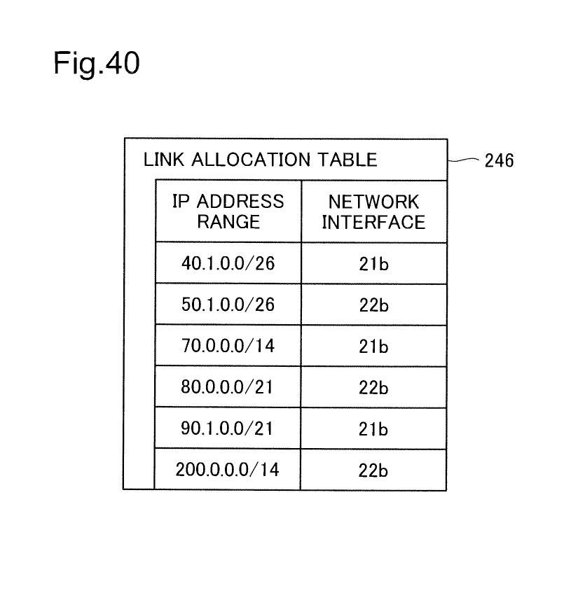

FIG. 40 is an explanatory diagram showing the link allocation table 246. The link allocation table 246 stores the IP address ranges notified by the internal network relay devices 300 as the connection destination of the link aggregation 50, and the network interfaces 21 and 22 of the self-device 200 correlated to the respective IP address ranges. The link allocation table 246 shown in FIG. 40 is created by the external network relay device 200b in the state that the IP space allocation table 357 of FIG. 26 is registered in the respective internal network relay devices 300.

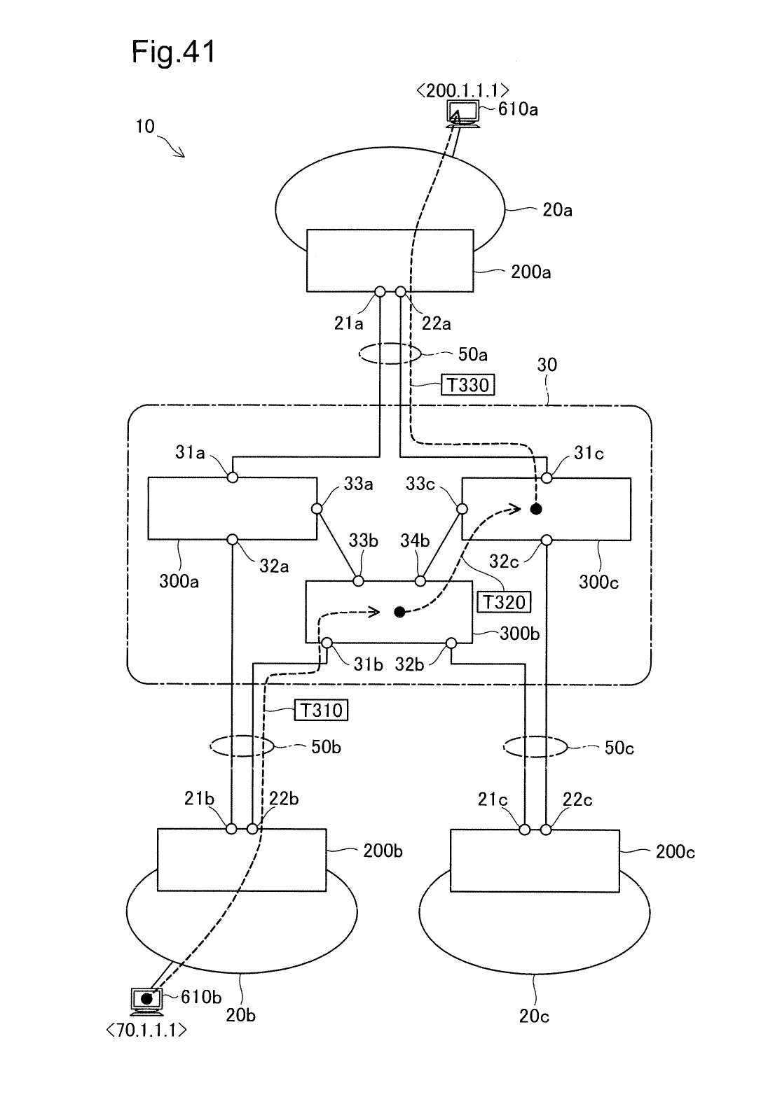

FIG. 41 is an explanatory diagram showing one example of data frame transfer in the third embodiment. Like the second embodiment, in the illustrated example of FIG. 41, a data frame is transferred from the terminal device 610b connecting with the external network 20b to the terminal device 610a connecting with the external network 20a.

### Transfer Operation T310

An IP address “200.1.1.1” of the terminal device 610a and an IP address “70.1.1.1” of the terminal device 610b are respectively set as the destination IP address and the source IP address in the IP header 720 of the data frame sent from the terminal device 610b. In the third embodiment, the external network relay device 200 receives the data frame from the terminal device 610b and searches the link allocation table 246 for a network interface of the self-device 200 correlated to the IP address range, which the destination IP address of the received data frame belongs to.

In the link allocation table 246 of FIG. 40, the destination IP address “200.1.1.1” belongs to an IP address range “200.0.0.0/14”, which is correlated to the network interface 22b. The external network relay device 200 accordingly transfers the data frame from the network interface 22b of the link aggregation 50b. The data frame sent from the terminal device 610b accordingly goes through the external network relay device 200 and is transferred to the internal network relay device 300b.

### Transfer Operation T320

When the network interface 31b receives the data frame, the internal network relay device 300b identifies which of the plurality of internal network relay devices 300 the route information corresponding to the destination IP address “200.1.1.1” of the data frame is allocated to, based on the IP space allocation table 357 of the self-device 300b. In the IP space allocation table 357 of FIG. 26, the destination IP address “200.1.1.1” belongs to the IP address range “200.0.0.0/14”, and the route information corresponding to the destination IP address “200.1.1.1” is allocated to the internal network relay device 300b, i.e., the self-device. The internal network relay device 300b accordingly searches the allocation route table 352b of the self-device 300b for route information corresponding to the destination IP address “200.1.1.1” of the data frame. The processing subsequent to the route search by the internal network relay device 300b is identical with the processing in the second example discussed above with reference to FIG. 32.

In the network relay system 30 of the third embodiment discussed above, each of the internal network relay devices 300 more actively receives a data frame with a destination IP address belonging to the IP address range allocated to the self-device 300, from the external network 20 connected via the link aggregation 50. This arrangement enhances the transfer speed of the data frame in the network relay system 30.

The external network relay device 200 of the third embodiment enhances the transfer speed of the data frame in the network relay system 30 including the internal network relay device 300 connected with the external network relay device 200 by the link aggregation 50.

As modified examples of the third embodiment, the configuration of the third embodiment may be applied to any of the configurations of the first embodiment, the modified examples of the first embodiment and the modified example of the second embodiment discussed above. In another modified example of the third embodiment, when a plurality of network interfaces are correlated to each IP address range in the link allocation table 246, one of the correlated network interfaces is selected for transfer of a data frame, based on a preset criterion, for example, the priority, the frequency in use, or the status of failure

### D. Modifications

The embodiments discussed above are to be considered in all aspects as illustrative and not restrictive. There may be many modifications, changes, and alterations without departing from the scope or spirit of the main characteristics of the invention.

For example, any of the configurations of the respective embodiments discussed above may be applied to route information forming a virtual private network (VPN). In this case, the allocation route table 352 and the other tables are provided for each VPN, which is established by the network relay system 30. This arrangement enables the routing process in the VPN to be effectively shared to the plurality of internal network relay devices 300 according to the longest match rule.

In the configurations of the respective embodiments discussed above, the plurality of internal network relay devices 300 in the network relay system 30 are constructed as the independent, separate devices, which cooperatively work to enable the network relay system 30 to integrally serve as the virtual single network relay device. In another embodiment, the plurality of internal network relay devices 300 may be located in a single casing, so that the network relay system 30 is physically constructed as a single network relay device.

In the embodiments discussed above, the internal network relay device 300 selected as the protocol processing device among the plurality of internal network relay devices 300 performs the transfer preparation process (step S200 or step S500). In another embodiment, a management device different from the internal network relay device 300 may alternatively perform the transfer preparation process (step S200 or step S500).

What is claimed is:

1. A network relay apparatus configured to interconnect a plurality of external networks, comprising:
a plurality of relay units configured to cooperatively construct an internal network for relaying a data frame, the data frame being to be sent and received between the plurality of external networks;
a route learner configured to learn multiple pieces of route information, each piece of the route information showing a route through which the data frame is to be transferred from the internal network to one of the external networks, and correlating an IP address range as an allocation range of a destination IP address of the data frame to a transfer destination of the data frame which is to be transferred from the internal network to the one of the external networks;
a route allocator configured to create a plurality of allocation route tables respectively corresponding to the plurality of relay units, wherein the multiple pieces of route information learnt by the route learner are allocated to the plurality of allocation route tables in units of the route information;
a space information generator configured to generate address space information showing a correlation of multiple IP address ranges on an IP address space between the multiple pieces of route information allocated to the plurality of allocation route tables; and
a route registrator configured to respectively register the plurality of allocation route tables, along with the generated address space information, in the plurality of relay units,
wherein each of the plurality of relay units transfers the data frame, based on the address space information and the allocation route table registered in the self-relay unit by the route registrator.

2. The network relay apparatus in accordance with claim 1, wherein the space information generator generates information that is correlated to each of the multiple pieces of route information allocated to the plurality of allocation route tables and shows whether route information in an IP address range belonging to a common IP address space and having a longer prefix length is allocated to another allocation route table among the plurality of allocation route tables, as the address space information.

3. The network relay apparatus in accordance with claim 2,
wherein each of the plurality of relay units includes:
a receiver configured to receive the data frame;
a route searcher configured to search the allocation route table registered in the self-relay unit by the route registrator for route information corresponding to a destination IP address of the data frame received by the receiver;
a first transferrer configured to, when address space information correlated to the route information searched by the route searcher indicates absence of the route information having the longer prefix length, set a destination address in a data link layer of the data frame received by the receiver, based on the route information searched by the route searcher, and transfer the data frame to the set destination address; and
a second transferrer configured to, when the address space information correlated to the route information searched by the route searcher indicates presence of the route information having the longer prefix length, transfer the data frame received by the receiver, in order to set the destination address in the data link layer of the data frame, based on the route information having the longer prefix length among pieces of route information searched by the route searchers of the plurality of relay units.

4. The network relay apparatus in accordance with claim 1,
wherein the space information generator includes:
a first generator configured to generate a plurality of aggregated address ranges by shortening prefix lengths of respective IP address ranges in the multiple pieces of route information learnt by the route learner and aggregating the IP address ranges having the shortened prefix lengths; and
a second generator configured to create an IP space allocation table in which the plurality of aggregated address ranges are allocated to the plurality of relay units, as the address space information, and
the route allocator allocates the multiple pieces of route information learnt by the route learner in units of the route information, based on the created IP space allocation table, so as to create the plurality of allocation route tables.

5. The network relay apparatus in accordance with claim 4,
wherein each of the plurality of relay units includes:
a receiver configured to receive the data frame;
a first transferrer configured to, when route information corresponding to a destination IP address of the data frame received by the receiver is present in the allocation route table registered in the self-relay unit by the route registrator, set a destination address in a data link layer of the data frame received by the receiver, based on the allocation route table registered in the self-relay unit by the route registrator, and transfer the data frame to the set destination address; and
a second transferrer configured to, when the route information corresponding to the destination IP address of the data frame received by the receiver is not present in the allocation route table registered in the self-relay unit by the route registrator, refer to the address space information registered in the self-relay unit by the route registrator, and transfer the data frame to a relay unit in which the route information corresponding to the destination IP address of the received data frame is registered.

6. The network relay apparatus in accordance with claim 1,
wherein each of the plurality of relay units includes: an instruction adder configure to, when the data frame is to be transferred to another relay unit among the plurality of relay units, add notification information to the data frame, the notification information being to be notified to the another relay unit, and
the notification information includes at least one of:
first information for identifying the another relay unit in the internal network;
second information for representing an operation requested to the another relay unit;
third information for representing a candidate for the route through which the data frame is to be transferred to the one of the external networks; and
fourth information for representing one or multiple relay units which the data frame has gone through, among the plurality of relay units,
the network relay apparatus further comprising;
an ARP learner configured to learn multiple pieces of ARP (Address Resolution Protocol) information, each piece of the ARP information correlating a destination address of a data link layer to each of transfer destination IP addresses, the transfer destination IP addresses being correlated as the transfer destinations to the IP address ranges of the multiple pieces of route information;
an APR allocator configured to create a plurality of ARP tables to which the multiple pieces of ARP information learnt by the ARP learner are allocated in units of the ARP information, according to allocation of the multiple pieces of route information to the plurality of allocation route tables; and
an ARP registrator configured to respectively register the plurality of ARP tables in the plurality of relay units.

7. The network relay apparatus in accordance with claim 6, further comprising:
a source address learner configured to learn multiple pieces of source address information, each piece of the source address information correlating a source address of the data link layer of the data frame to each of the destination addresses in the multiple pieces of ARP information;
a source address allocator configured to create a plurality of source address tables to which the multiple pieces of source address information learnt by the source address learner are allocated in units of the source address information, according to allocation of the multiple pieces of ARP information to the plurality of ARP tables; and
a source address registrator configured to respectively register the plurality of source address tables in the plurality of relay units.

8. The network relay apparatus in accordance with claim 1, wherein the route allocator creates the plurality of allocation route tables such that an identical piece of the route information is allocated in a duplicative manner to at least two allocation route tables.

9. The network relay apparatus in accordance with claim 1,
wherein each of the plurality of relay units is operable in parallel as the route learner, the router allocator, the space information generator and the route registrator, and
a relay unit to be operated in parallel as the route learner, the router allocator, the space information generator and the route registrator is selected among the plurality of relay units.

10. The network relay apparatus in accordance with claim 1, wherein each of the plurality of relay units includes: a route notifier configured to notify an external network connected with the self-relay unit via a link aggregation among the plurality of external networks, of an IP address range in the allocation route table registered in the self-relay unit by the route registrator.

11. The network relay apparatus in accordance with claim 1, wherein the multiple pieces of route information form a VPN (Virtual Private Network).

12. The network relay apparatus in accordance with claim 1,
wherein the plurality of relay units are individually provided as a plurality of independent, separate network relay devices, and
the plurality of independent, separate network relay devices cooperatively work as a virtual single network relay device.

13. A network relay system configured to interconnect a plurality of external networks, comprising:
a plurality of network relay devices configured to cooperatively construct an internal network for relaying a data frame, the data frame being to be sent and received between the plurality of external networks;
a route learner configured to learn multiple pieces of route information, each piece of the route information showing a route through which the data frame is to be transferred from the internal network to one of the external networks, and correlating an IP address range as an allocation range of a destination IP address of the data frame to a transfer destination of the data frame which is to be transferred from the internal network to the one of the external networks;
a route allocator configured to create a plurality of allocation route tables respectively corresponding to the plurality of network relay devices, wherein the multiple pieces of route information learnt by the route learner are allocated to the plurality of allocation route tables in units of the route information;
a space information generator configured to generate address space information showing a correlation of multiple IP address ranges on an IP address space between the multiple pieces of route information allocated to the plurality of allocation route tables; and
a route registrator configured to respectively register the plurality of allocation route tables, along with the generated address space information, in the plurality of network relay devices,
wherein each of the plurality of network relay devices transfers the data frame, based on the address space information and the allocation route table registered in the self-network relay device by the route registrator.

14. A network relay method of interconnecting a plurality of external networks, comprising:
interconnecting a plurality of network relay devices to cooperatively construct an internal network for relaying a data frame, the data frame being to be sent and received between the plurality of external networks;
learning multiple pieces of route information, wherein each piece of the route information shows a route through which the data frame is to be transferred from the internal network to one of the external networks, and correlates an IP address range as an allocation range of a destination IP address of the data frame to a transfer destination of the data frame which is to be transferred from the internal network to the one of the external networks;
creating a plurality of allocation route tables respectively corresponding to the plurality of network relay devices, wherein the learnt multiple pieces of route information are allocated to the plurality of allocation route tables in units of the route information;
generating address space information, which shows a correlation of multiple IP address ranges on an IP address space between the multiple pieces of route information allocated to the plurality of allocation route tables;
respectively registering the plurality of allocation route tables, along with the generated address space information, in the plurality of network relay devices; and
transferring, by each of the plurality of network relay devices, the data frame, based on the address space information and the allocation route table registered in the self-network relay device.

15. A network relay apparatus configured to relay a data frame, comprising:
a plurality of interfaces configured to respectively connect with a plurality of connection destinations and cooperatively form a single virtual interface by a link aggregation;
an allocation learner configured to learn an IP address ranges from the each connection destination and correlate the learnt IP address range to the interface corresponding to the connection destination from which the IP address range is learnt, the IP address range being an allocation range of a destination IP address of the data frame which is to be routed by the each connection destination; and
a transferrer configured to, when the destination IP address of the data frame which is to be sent from the virtual interface belongs to the IP address range learnt by the allocation learner, transfer the data frame from the interface correlated to the IP address range by the allocation learner among the plurality of interfaces.
